(19) United States
(12) Patent Application Publication
(10) Pub. No.: US 2009/0094631 A1
(43) Pub. Date: Apr. 9, 2009

(54) SYSTEMS, APPARATUS AND METHODS TO ASSOCIATE RELATED MARKET BROADCAST DETECTIONS WITH A MULTI-MARKET MEDIA BROADCAST

(76) Inventors: Thomas J. Whymark, Bethlehem, PA (US); Joseph Kaminski, Denville, NJ (US); James M. Rathburn, Hackensack, NJ (US); Stephen Shindle, Scotch Plains, NJ (US); Hui-Tung Yang, Berkeley Heights, NJ (US); Huaiyeu Huey Yu, Branchburg, NJ (US)

Correspondence Address: Hanley, Flight & Zimmerman, LLC, 150 S. Wacker Dr. Suite 2100, Chicago, IL, 60606, US

(21) Appl. No.: 12/242,192

(22) Filed: Sep. 30, 2008

Related U.S. Application Data
(60) Provisional application No. 60/976,692, filed on Oct. 1, 2007.

(51) Int. Cl. H04N 7/16

(52) U.S. Cl. 725/22

(57) ABSTRACT

Systems, apparatus and methods to associate related market broadcast detections with a multi-market media broadcast are disclosed. An example disclosed method comprises obtaining a plurality of broadcast detection records, each broadcast detection record comprising detection information obtained by detecting an instance of a broadcast item in a broadcast market, comparing the plurality of broadcast detection records using first association criteria to identify a first group of broadcast detection records from the plurality of broadcast detection records, comparing the plurality of broadcast detection records using second association criteria to identify a second group of broadcast detection records from the plurality of broadcast detection records, the second association criteria different from the first association criteria, and determining a third group of broadcast detection records from the plurality of broadcast detection records to associate with a multi-market media broadcast, the third group corresponding to a larger of the first and the second group.

### RELATED APPLICATION(S)

This patent claims priority from U.S. Provisional Application Ser. No. 60/976,692, entitled “Systems and Methods to Associate Related Market Broadcast Detections into National Detections” and filed on Oct. 1, 2007. U.S. Provisional Application Ser. No. 60/976,692 is hereby incorporated by reference in its entirety.

### FIELD OF THE DISCLOSURE

This disclosure pertains to the field of commercial broadcast advertising and, in particular, to systems, apparatus and methods to associate related market broadcast detections with a multi-market media broadcast.

### BACKGROUND

Broadcasts on commercial broadcast mediums, such as commercial radio or television airwave frequencies, cable television systems, or satellite television or satellite radio systems typically include commercial advertising interspersed within and among featured programs, such as shows, sporting events and news programs. Broadcasts are transmitted on predefined channels of broadcast mediums. However, a particular broadcast may be transmitted on more than one broadcast medium at the same time. In particular, broadcast television stations, which historically transmitted solely via commercial television airwaves, are now commonly re-transmitted via (i.e., are carried by) cable television systems and satellite broadcast systems as well. Further, the broadcast medium used to deliver the broadcast to a consumer may be operated by a carrier system that is independent of the originator of the broadcast—as is often the case with a broadcast from a broadcast television station delivered to consumers via a cable or a satellite television system.

The broadcasts of multi-market broadcasters, such as national television broadcast networks, national cable network channels, national radio broadcast networks, satellite channels, and the like, include multiple broadcast markets. Examples of national television broadcast networks include ABC, NBC and CBS; examples of national cable network channels include ESPN, CNN, The Comedy Channel, The Weather Channel, etc. To compensate for time differences between distant markets, multi-market broadcasters may transmit (or may direct others to transmit on their behalf) multiple feeds of their broadcast. These feeds may be simply time-delayed or may also include changes in the programming. Some events, like speeches and certain championship sporting events, may be covered live across all time zones.

The responsibility for the selection and arrangement of featured programs (i.e., the programming) varies by the type of broadcaster. In the case of television broadcasts, local television stations typically have an affiliation to (and may be owned by) a national television broadcast network (e.g., ABC, NBC, or CBS). The national television broadcast network typically determines and provides all of the programming during predefined “prime time” hours, which are generally the evening hours during which the viewing audience reaches a maximum. The programming during these time periods may be delivered to each affiliated local television station from the national television broadcast network in one or more so called “network feeds.” Local radios stations may have a similar affiliation with a national radio broadcast network that determines certain programming of the local radio station broadcast.

The programming of local broadcasters and of multi-market broadcasters (e.g., a national cable network channel) may also be provided in part by a syndicator, which owns rights to distribute certain programs that are in “syndication.” In the case of a local television broadcaster affiliated with a multi-market broadcast network, programming provided by a syndicator is broadcast in non-prime time hours. Typically syndicators provide programming in all or a large number of the markets in a nation or region.

For the purposes of this description, the organization that determines the programming of a broadcast is described as the broadcast originator or distributor of that programming. Thus, a national broadcast television network is the broadcast originator or distributor of programming which is (usually) aired during prime time hours, and other shows of national interest, which the network produces for its affiliates to carry. Examples of non-prime time hour shows which a network produces are news shows such as Meet The Press, some sporting events such as the Kentucky Derby, or even network-produced soap operas. Many times the network feed is carried live by the affiliate, but sometimes the local affiliate may elect to shift the time of the program. Similarly, a syndicator distributes its programming to stations around the country. However these program offerings are not restricted to any one network, and could be on, for example, the ABC affiliate in one market, CBS in another, FOX in a third, etc. Further, the broadcast time may vary from market to market. Finally the local station is the originator of some of its programming. For example, a local television station is typically the broadcast originator (or distributor) of non-prime time programming not in syndication, such as a local news program.

Advertisers of commercial goods and services may purchase space for advertising from any of the three types of broadcast originators (or distributors) during the time for which the distributor is the broadcast originator for the programming of a broadcast. An advertising “buy” from a particular distributor may include detailed specifications as to the space(s) desired for the advertisement, such as the featured programs, dates, days of the week, time range, duration, markets and number of instances. The purchase may be for commercial air time on a market or outlet basis (spot or local cable), or it could be at the national network level where it is part of the national feed sent out across the country. Advertisers also include detailed specifications as to the particular content or advertisements to be placed in the desired spaces (i.e., “traffic” information) sometimes with the buy details and other time as a separate set of instructions. The combination of the buy and traffic specifications is referred to herein as “flight information.”

To enhance the effect of broadcast advertising campaigns, an advertiser will often purchase advertising space from a number of different distributors with varied buy and traffic information. Further, typically such purchases may be arranged and managed by an advertising agency or media buyer that may have a large number of such clients. Therefore, it can be appreciated that the tasks of managing and confirming fulfillment of advertising orders can be complex and burdensome.

In an effort to confirm that orders for advertising have been properly fulfilled, entities responsible for broadcasting advertisements (i.e., the broadcast originators or distributors) may employ independent human viewers to manually catalog broadcasts of advertisements. However, this method for confirming orders is subject to human error, and may not be feasible for the currently large and continually growing number of broadcasts. Further methods include electronic monitoring of broadcasts.

### BRIEF DESCRIPTION OF THE DRAWINGS

FIG. 1 illustrates a flowchart representative of an example process to associate and/or confirm fulfillment of broadcast advertisement orders.

FIG. 2 is a block diagram of an example system to associate and/or confirm fulfillment of broadcast advertisement orders.

FIGS. 3-11 are examples reports and queries generated by the example method and/or system of FIGS. 1 and/or 2.

FIGS. 12-15 are example tables that may be generated and/or used by the example method and/or system of FIGS. 1 and/or 2.

FIG. 16 illustrates a flowchart representative of an example process for associating detections corresponding to broadcast advertisements that may be executed to implement the example method and/or system of FIGS. 1 and/or 2.

FIG. 17 is a block diagram of an example computer that may be used to implement the example system of FIG. 2 and/or that may execute example machine readable instructions to implement the example processes of FIGS. 1, 16, 19-22 and/or 23 to implement the example system of FIG. 2 and/or the example record association apparatus of FIG. 18.

FIG. 18 is a block diagram of an example record association apparatus that may be used to implement the example system of FIG. 2.

FIG. 19 illustrates a flowchart representative of an example process to implement an example schedule method for associating detections corresponding to broadcast advertisements which may be used to implement the example process of FIG. 16.

FIG. 20 illustrates a flowchart representative of an example process to implement an example network method for associating detections corresponding to broadcast advertisements which may be used to implement the example process of FIG. 16.

FIG. 21 illustrates a flowchart representative of an example process to implement an example episode method for associating detections corresponding to broadcast advertisements which may be used to implement the example process of FIG. 16.

FIG. 22 illustrates a flowchart representative of an example process to implement an example feed method for associating detections corresponding to broadcast advertisements which may be used to implement the example process of FIG. 16.

FIG. 23 illustrates a flowchart representative of an example process to combine the example schedule method, network method, episode method and feed method processes of FIGS. 19, 20, 21 and 22, respectively, which may be used to implement the example process of FIG. 16.

### DETAILED DESCRIPTION

This disclosure relates to broadcast advertisement tracking, managing and reporting methods, apparatus and systems that provide accurate, independent confirmations of the fulfillment of broadcast advertising orders, that match multi-market broadcasts of advertisements to multi-market advertising orders, that report fulfilled and unfulfilled orders and that provide such matching, confirmation and reporting for a large number of broadcasts over a large number of broadcast markets.

A disclosed example system discussed below confirms fulfillment of orders for broadcast items, such as commercial advertising orders, and provides dynamic reports of fulfilled and unfilled orders. The system includes a plurality of electronic detection devices located in the various broadcast markets that are configured to receive and analyze broadcasts on a number of channels of a number of broadcast mediums.

The example detection devices detect instances of actual broadcasts of encoded broadcast items, such as encoded advertisements, and record information regarding each detected actual broadcast in a log. In an example implementation, any suitable method for encoding or assigning unique codes to broadcast items may be employed. However, preferably the detection devices in such an example implementation are able to detect the date, time, channel and duration of the broadcast item, in addition to the code.

In the example system, detection information is consolidated from the plurality of detection devices and processed. In the processing of detections, related multi-market detections of instances of actual broadcasts of encoded broadcast items are associated to one another, by one or more computing devices, using reference data and one or more published program schedules. The associated multi-market detections are then associated with a related multi-market order received from an advertiser or agency to indicate whether, and to what extent, the multi-market order has been fulfilled. Further, single-market detections of instances of actual broadcasts of encoded broadcast items are associated with related market focused advertising orders (i.e., “spot” buys) to indicate whether (and to what extent) the single-market advertising order has been fulfilled. In addition to recognizing accurately fulfilled advertising orders, the system also recognizes a number of commonly occurring errors in fulfilling orders, such as the broadcast of an incorrect advertisement in the correct space. The system also provides detailed reports of fulfilled, erroneous and unfulfilled advertising orders. The ability to quickly and conveniently access (or “drill down” to) detailed information regarding the individual detections associated with multi- and single-market advertising orders is also supported.

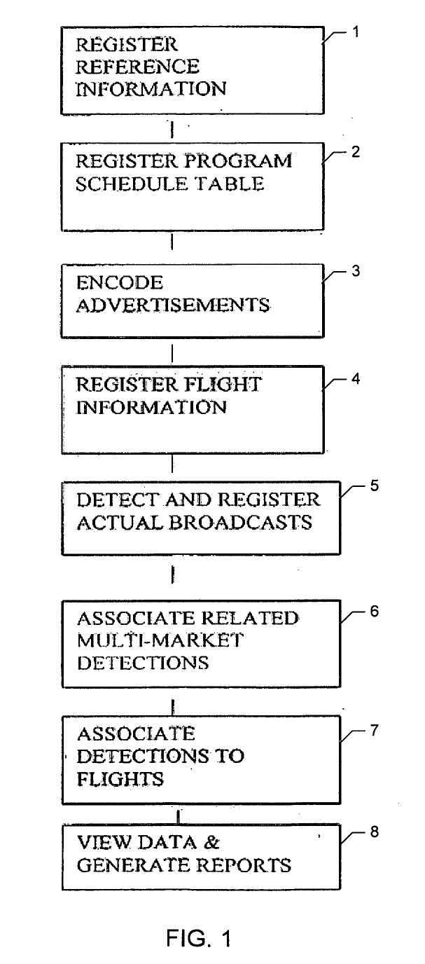

Reference Information (Block 1 of Example Process of FIG. 1)

Referring to FIG. 1, the example process to associate and/or confirm fulfillment of broadcast advertisement orders begins with the gathering and registration of certain reference information to be used in associating related detections of actual broadcasts of encoded broadcast items (e.g., encoded advertisements) with one another, and in associating such detections to related advertising orders (block 1). Such reference information includes advertising agency (media buyer) information, broadcaster information, syndication information, monitoring device information, and authorized user information.

Agency Information: Agency information includes information on the advertisements for which each agency is responsible, and the time allowances for each agency, which may vary depending on the client, brand, product, and the type of advertising (e.g., national broadcasts to be heard in multiple markets, or broadcasts in single markets).

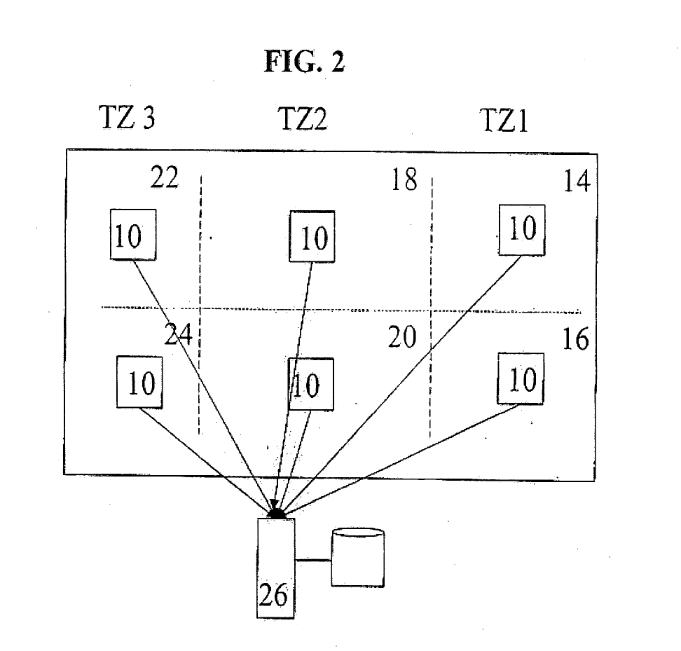

Preferably, in the example process of FIG. 1 and/or the example system of FIG. 2, clients with both multi-market and single-market advertising campaigns are given two distinct AGENCY, CLIENT, BRAND, and PRODUCT code combinations to distinguish campaigns in the system and to allow variations in other configurations of the system. For example, a first AGENCY, CLIENT, BRAND, and PRODUCT code combination may be associated with a single-market advertising campaign, and a second AGENCY, CLIENT, BRAND, and PRODUCT code combination may be associated with a multi-market advertising campaign.

Agency information also includes information regarding the time allowances customarily given to distributors for placing advertisements, which may vary depending on the agency-client-brand-product combination, and whether the advertisement is for a multi-market (e.g., national) advertising campaign or a single-market campaign. A time allowance is the permitted time of broadcast tolerance around the agreed broadcast time, usually specified in minutes. For example, the time allowance is commonly +/−2 minutes for a single-market advertising order and 0 minutes for a multi-market (or “national”) order. This information may be stored in a time allowance database table having the fields identified below.

Time Allowance Table

AGENCY NAME (or code)
CLIENT NAME (or code)
FROM TIME ALLOWANCE
END TIME ALLOWANCE
BRAND NAME (or code)
PRODUCT NAME (or code)

Flight Information: As mentioned above, flight information includes a combination of buy specifications (e.g., such as the space(s) desired for the advertisement, such as the featured programs, dates, days of the week, time range, duration, markets, number of instances, etc.) and traffic specifications (e.g., such as the particular content or advertisements to be placed in the desired space(s)). In flight information, different agencies may use different abbreviations or codes for the same channels or distributors. For example, one agency may use “DSC” for “The Discovery Channel”, while another may use “DISC” or “TDC”, etc. Therefore, the example system of FIG. 2 preferably includes a call letter translation table to convert call letters provided by agencies in flight information to a standard code for the system. The call letter translation table may contain the following fields:

Call Letter Translation Table

CALL LETTER (to be translated into a system standard representation)
SYSTEM VERSION OF CALL LETTER
BROADCAST MARKET (e.g., “NY” or “LA”, etc. for single-market
or “NATL” for multi-market, or national)
NATIONAL CALL LETTER (affiliated network if broadcast station)
STATION TYPE

For example, broadcast station WABC in New York would be defined as WABC, NY, ABC, TV; national cable channel SCIFI would be defined as SCIFI, NATL, SCIFI, CTV; national syndicator Kingworld would be defined as NBC-UT, NATL, NBC KINGWORLD, STV; and national network ABC would be defined as ABC, NATL, ABC, TV.

The example system of FIG. 2 also contains additional information regarding the “prime time” of national broadcast networks. This information can be stored in a prime time table having the following fields:

Prime Time Table

NATIONAL CALL LETTER
BROADCAST MARKET
DAY OF WEEK
FROM TIME
TO TIME

Market Information: Market information includes information regarding each of the regional markets, such as, for example NY, LA, SF, etc, which contain monitoring devices. In an example application, satellite feed monitoring devices are considered a pseudo market. For example, monitoring of an East Satellite feed could be considered monitoring of the E_FEED market. The market information can be stored in a market information table having the following fields:

Market Information Table

MARKET CODE
MARKET NAME
MARKET TIME ZONE SETTINGS
MARKET SEQUENCE FOR NATIONAL PROCESSING

Syndication Information: The information regarding syndications includes syndicator names, which may be partial or complete names and an associated code for the syndicator, which may be an abbreviated code. This information may be stored in a syndicator table having the following fields:

Syndicator Table

SYNDICATOR NAME
SYNDICATOR CODE

Syndication information also includes programs known to be in syndication and the associated syndicator. This information may be stored in a syndication programs table having the following fields:

Syndication Programs Table

SYNDICATION PROGRAM NAME
SYNDICATOR CODE

Syndication information further includes a list of programs in syndication that appear on different days of the week in different markets. This information may be stored in a weekly syndication table having the following field:

Weekly Syndication Table
SYNDICATION PROGRAM NAME

Split Channels: Cable distributors sometimes elect to vary the source of the broadcast that is distributed on a given frequency (channel). For example, a cable distributor may choose to air children's programming in the morning, and then change the feed to pick up a news program in the afternoon and evening. As another example, a cable network may sublet part of its broadcasting day to another channel.

To properly attribute the source of the broadcast, the system preferably includes a split channel table having the following fields:

Split Channel Table

REPORTED CALL LETTER
BROADCAST MARKET
MONDAY
TUESDAY
WEDNESDAY
THURSDAY
FRIDAY
SATURDAY
SUNDAY
FROM TIME
TO TIME
SOURCE CALL LETTER

Monitoring Device Information: The information regarding the electronic monitoring devices of the example system of FIG. 2 includes a unique identifier for each device and the broadcast market in which the device is physically located. This information may be stored in one or more monitoring device tables, each having the following fields:

Monitoring Device Table

DEVICE I.D.
DEVICE MARKET

Time zone settings for each detection device location: Another reference table of the example system of FIG. 2 contains information that defines the default time adjustment value for each market that is to be applied to detections on cable networks to associate related actual detection records to each other. From a schedule time adjustment viewpoint, the primary difference between broadcast networks and national cable networks is that national cable networks typically transmit the same signal across multiple time zones. So, the published schedules of national cable networks span multiple time zones. Therefore, the system includes a table that holds the appropriate time adjustments for cable network programs in specific markets with respect to a base time zone (e.g., such as eastern time (ET) in the United States (U.S.)). The information may be stored in a national cable adjustment table having the following fields:

National Cable Adjustment Table

NATIONAL CALL LETTER
BROADCAST MARKET
TIME ADJUSTMENT
SEASONAL TIME SHIFT (fmdttm (from date and time) & todttm (to
date and time) range)
FEED (e.g., “East” or “West”U.S.)

With reference to, but not limited to, application in the U.S., cable networks may have one feed or may have multiple, time-delayed feeds. To account for the difference in the local time of programs in different markets, the TIME ADJUSTMENT fields of the records in the national cable adjustment table for each market include a time adjustment value appropriate to adjust a local time of a program or detection in that market to the corresponding time in a base time zone (e.g., ET).

In the case where a cable network has one feed, the programs are aired simultaneously in each market. In this instance, the local time of each program will vary depending on the time zone of the market. Thus, a record in the national cable adjustment table for the Los Angeles (LA) market for a one-feed cable network may have a TIME ADJUSTMENT field equal to −180 (minutes), assuming the base time zone corresponds to U.S. Eastern Time (ET), which may be Eastern Standard Time (EST) or Eastern Daylight Savings Time (EDT) depending upon the time of year.

Other cable networks have multiple feeds, which in the U.S. are usually identical East and West coast feeds, with the West coast feed being delayed 3 hours to adjust for the time difference between the Eastern and Pacific time zones. Thus, a program broadcast at a local time of 9 p.m. on the East coast is also broadcast at a local time of 9 p.m. for the West coast. However, the program may appear at a different local time in markets in time zones between the Eastern and Pacific time zones, such as markets in the Central and Mountain time zones depending on a particular market's time zone and DST setting. For example, if a cable operator in Denver chooses to use the East coast feed, a program broadcast at 9 p.m. ET is broadcast in Denver at 7 p.m. local time. However, if the same cable operator chooses to use the West Coast feed, a program broadcast at 9 p.m. PT program in LA is broadcast in Denver at 10 p.m. local time.

Thus, the values of the TIME ADJUSTMENT fields in the records of national cable adjustment table for such multi-feed cable networks for certain markets (e.g., markets in the Eastern and Pacific time zones in the U.S.) will be zero (0). However, the values of such TIME ADJUSTMENT fields for markets between the Eastern and Pacific time zones will depend on which feed the particular market receives (i.e., either the East or West coast feed) and the relevant time zone. Such values are preferably predetermined and placed in the appropriate records of the national cable adjustment table. As above, these TIME ADJUSTMENT values of the national cable adjustment table are employed to populate the TIME ADJUSTMENT fields of records in the program schedule table during processing of the cable network schedules.

Program Schedule Table (Block 2 of the Example Process of FIG. 1)

Published Schedule Information: After registering the reference information (block 1), the example process of FIG. 1 gathers and registers published schedule information from different markets to build a multi-market schedule table (block 2). Certain schedules, such as television broadcast and cable schedules are published in advance and are publicly available. Further, such schedules are often available in electronic format, or in a format that may be converted to an electronic format. Typically, separate schedules are published for each television market and include a date, a name (or description) of each featured program (which program may be a show, sporting event or news event, etc.), a channel number, call letters for the broadcaster, and a start and end time. This information is gathered from the published schedules preferably by a computer executing machine readable instructions adapted to locate and extract the desired information. The scheduled program data is preferably gathered on a regular basis, for example daily or weekly. A history of schedule information is preferably maintained in the program schedule table until such time as it is no longer needed.

Once gathered, the information is placed into the following fields of the program schedule table:

Program Schedule Table

DATE
PROGRAM NAME
BROADCAST MARKET
CALL LETTER
TYPE OF STATION
START TIME
END TIME
NATIONAL CALL LETTER
DISTRIBUTOR
TIME ADJUSTMENT

Distributor Determination: Then, for each program listing in the program schedule table, a look-up is performed in the station table, based on the CALL LETTER field of the program schedule table to determine the network affiliation of the broadcaster of each program listing, if any. The code for the network affiliation of the broadcaster, if any, is then placed in the NATIONAL CALL LETTER field and in the DISTRIBUTOR field of the appropriate record in the program schedule table. This indicates, at least presumptively, that the affiliated national broadcast network is responsible for the program. If there is no network affiliation for the broadcaster, then the value in the CALL LETTER is copied to both the NATIONAL CALL LETTER field and DISTRIBUTOR field to indicate, at least presumptively, that the local broadcaster is responsible for the program.

Then, each program listing in the program schedule table is compared to the prime time table information to determine if the program listing occurs outside “prime time” for that broadcast market/national call letter/day-of-week combination. If the program listing occurs outside the FROM TIME and TO TIME of the BROADCAST MARKET+NATIONAL CALL LETTER+DAY OF WEEK combination, then the PROGRAM NAME in the program schedule table is compared to the SYNDICATION PROGRAM NAME field in the syndication program table to determine if the program is a known program in syndication. If a match is found, then the associated SYNDICATOR CODE of the syndication program table is copied to the DISTRIBUTOR code of the program schedule table to indicate that the syndicator is responsible for the program.

Intra-day Time Adjustments: For each schedule date, the START TIME for each program listing in the program schedule table is then compared to the START TIME of a first occurrence of a like DATE+PROGRAM NAME+DISTRIBUTOR combination in the program schedule table in a base market (e.g., the New York (NY) market). A TIME ADJUSTMENT field in the record for the first occurrence in the base market is set to zero (0) and the TIME ADJUSTMENT field in the compared record is set to the time difference (in minutes) between the START TIME of the first occurrence of the combination and the START TIME of the compared record. Preferably, the TIME ADJUSTMENT field has a negative value if the value in the START TIME field of the first occurrence of the combination in the base market is greater than that of the compared record.

Non-Standard Overrides: If desired, the TIME ADJUSTMENT field for certain program listings may be corrected using predefined program instructions specifically tailored to set the correct time adjustment value for specific DATE+DAY OF WEEK+BROADCAST MARKET+START TIME combinations.

Weekly Syndication: Some programs in syndication occur on different days of the week in different markets. Therefore, after the intra-day time adjustment process is completed, the PROGRAM NAME field of each program listing in the program schedule table within a 7-day (inter-day) window, in the base market (e.g., the NY market), is compared to the SYNDICATION PROGRAM NAME field of the syndications programs table. If a match is found, then the program listings for all markets within the same inter-day window are compared to the first occurrence of the PROGRAM NAME+DISTRIBUTOR combination in the base market. If a match is found, the TIME ADJUSTMENT field of the compared record is adjusted according to the difference in time (in minutes) between the DATE+START TIME of the first occurrence of the program and the DATE+START TIME of the compared record. For example if a syndicated weekly program is scheduled to first occur in the NY market on Friday at 10:30 a.m., but it also occurs in the LA market on Thursday at 9:30 a.m., then the TIME ADJUSTMENT field for the program listing in the LA market would be −1500 minutes (25 hours.times.60 minutes/hour earlier).

Cable Networks: A separate schedule process is used to analyze and register the program schedules for cable networks. Broadcast station schedules are relatively complex and are therefore preferably stored individually. Schedules for national cable channels are not as complex, and need not be stored separately on a market by market basis, one per feed is stored.

As stated above, cable networks may have a single feed or may have multiple, time-delayed feeds. For single-feed cable networks, preferably only one record is created in the program schedule table for each program, and the START TIME and END TIME for the record are the times in the base time zone (e.g., ET). For multiple-feed cable networks, preferably one record is created for each feed for each program (e.g., 2 records for each program for a cable network having East cost and West coast feeds), and the START TIME and END TIME of the records are set according to, for example, the Eastern and Pacific time zones.

For cable networks with multiple feeds, each schedule is compared to the schedule of the base market in a manner similar to that described above for broadcast stations and the local time difference (if any) between programs is placed in the TIME ADJUSTMENT field of the record in the program schedule table related to that program for that feed. If the schedules of each feed are merely time delayed and are otherwise identical, the local times of related programs will be the same. Thus, the TIME ADJUSTMENT fields will contain a value of zero (0).

Encode Advertisements (Block 3 of the Example Process of FIG. 1)

By industry custom, individual advertisements are each assigned a unique code that may be used to distinguish the advertisement from others and may be used to determine the advertising agency-client-brand-product combination responsible for the advertisement. This code is often referred to as the Industry Standard Commercial Identifier (ISCI) code or the Ad-Id.

Advertisements or other broadcast items to be tracked by the example system are assigned a unique detection code, which is preferably the same as the associated ISCI code. Preferably, the detection code is embedded within the audio and/or video signal of the advertisement in a manner that permits the electronic extraction of the detection code during subsequent playback of the advertisement using specially adapted detection equipment.

Additionally or alternatively, signature generation and comparison techniques may be used by the example system to identify the advertisements and/or other broadcast items being tracked. In the media measurement industry, a signature is any (preferably unique) inherent characteristic of the signal that can be used to identify the content. Preferably, the signature has less data than the full content signal and, thus, functions as a proxy for that signal. In an example implementation, one or more signatures generated from monitored content are compared to a plurality of reference signatures corresponding to respective known reference content sources. If the signature(s) for the monitored content match reference signature(s) for a particular reference content source, the monitored content is then identified as corresponding to that particular content source.

Information regarding the encoded advertisements may be held in an encoded advertisements table having the following fields:

Encoded Advertisements Table

AGENCY ISCI CODE
CLIENT NAME (or code)
AGENCY NAME (or code)
BRAND NAME (or code)
CLIENT NAME (or code)
DURATION
MULTI-MARKET BROADCAST
COMMERCIAL TITLE

When commercials are registered in the example system of FIG. 2, the MULTI-MARKET BROADCAST field is set to indicate whether the commercial is intended for a multi-market (e.g., national) advertising order or for a single-market advertising order, where, for example a value of “Y indicates a national order. Since agencies can be hired and fired, it is possible that a previously encoded commercial could be used in a new advertising campaign by a new agency. In the illustrated example system, information regarding the agency, the advertisements associated with the agency and the date range that the agency is associated with the advertisement are held in an agency commercial table having the following fields:

Agency Commercial Table

AGENCY ISCI CODE
AGENCY NAME (or Code)
CLIENT NAME (or code)
BRAND NAME (or code)
PRODUCT NAME (or code)
START DATE
END DATE
ENCODED ISCI CODE (corresponding to the detected code and/or
signature)

Flight Information (Block 4 of the Example Process of FIG. 1)

Flight information may be provided by (or on behalf of) an agency in two parts—one part containing the “buy” information and a second part containing the traffic information, or may be provided as one unit. Buy information may be delivered or available in electronic form, such as an ASCII text computer file having separate line items for the buy information. The format of such files may vary somewhat depending on the agency or source, however the format is usually similar amongst different sources and is typically consistent within any given source. Traffic information may be delivered electronically, verbally or in paper form. Buy information typically includes the following information:

BUY-CLIENT
BUY-PRODUCT
PRODUCT DESCRIPTION
ESTIMATE NUMBER
MARKET
CALL LETTER
NATIONAL CALL LETTER
START DATE
END DATE
DAY ROTATION (e.g., M-F, SAT)
LENGTH OF SPOT
START TIME
END TIME
PROGRAM NAME
UNITS
AGENCY ISCI CODE (from some sources)

The system has another table that describes how to translate or map the client/product codes from an agency's billing system to the system's internal AGENCY-CLIENT-BRAND-PRODUCT settings. The system takes the settings from the buy information and references this table to determine how to map the specific buy to its Agency-Client-Brand-Product-FlightType combination.

This table consist of the following fields

BILL_PRODUCT
BILL CLIENT
BILL ESTIMATE
AGENCY NAME (or code)
CLIENT NAME (or code)
BRAND NAME (or code)
PRODUCT NAME (or code)
FLIGHTTYPE of PRODUCT (National or Spot)

With the connection set to the proper account setting, the buy information is preferably first loaded into one of a plurality of holding tables that is specific to the source of the buy information. This loading process is preferably accomplished using a parsing program which is specific to the source of the buy information.

Then a conversion program converts the buy information into the format described below and loads the information into a flight information table. In the conversion, a separate record is created for every unit specified in each line item of the buy information. For example, if a line item of the buy information specifies 3 UNITS, then the line item of the buy information will be converted to three records in the flight information table, each record having an ITEM NUMBER of “1 of 3”, “2 of 3” or “3 of 3”, respectively. The total number of spots in the line item of the buy information is recorded in a TOTAL SPOTS field in each of the records related to the line item of the buy information. Further, the START DATE, END DATE and DAY ROTATION information indicated in the line item of the buy information is converted (if necessary) to a WEEK OF field and daily fields: MONDAY, TUESDAY, WEDNESDAY, THURSDAY, FRIDAY, SATURDAY and SUNDAY. For example, if the DAY ROTATION value in the buy information was M-W, the values for the daily fields would be Y, Y, Y, N, N, N and N, respectively.

Further, during conversion, a look-up is performed in the time allowance table, based on the AGENCY-CLIENT-BRAND-PRODUCT fields in each flight record to obtain the associated time allowance from the time allowance table. A FROM ALLOWANCE field of the flight record is set to equal the FROM TIME field less the FROM TIME ALLOWANCE, and a TO ALLOWANCE field of the flight record is set to equal the TO TIME field plus the TO TIME ALLOWANCE. If the traffic information is included with the buy information, the associated ISCI codes are placed in an ISCI GROUP field for each record of the flight information table.

If the traffic information is delivered separately from the buy information, then the associated ISCI codes for the line item of the buy information are added manually either prior, during or after conversion of the buy information to the flight information table. ISCI information, if not provided in the buy schedule, can be entered into a Traffic Rules table. This table allows the system to automatically apply predefined traffic rules to new revisions in flights. These rules tell the system how to fill in default ISCI values or filter out items in the flight which are not being tracked.

Further, if the buy information relates to a multi-market (e.g., national advertisement order), the CALL LETTER field of the record in the flight table for each line in the buy contains the National Network, Cable or Syndication call letter. (e.g., “ABC” for the ABC network), and the BROADCAST MARKET field value is set to “NATL”. If the buy is for a single-market or local distributor level than the CALL LETTER field will contain the call letter for the local broadcaster or cable channel and the BROADCAST MARKET field value is set to the value of that individual market (e.g., “NY” or “LA”, etc.). The BROADCAST MARKET is obtained via a look up of the market in the station table. The call letter translation table may be employed during this process to translate call letters provided by the agency.

After the conversion is performed and the initial reference information is added, the following fields of the flight information table are generally populated.

Flight Information Table

CLIENT
ESTIMATE NUMBER
AGENCY
BRAND
PRODUCT
CALL LETTER
BROADCAST MARKET
PROGRAM NAME
TOTAL SPOTS PURCHASED
ITEM NUMBER
FROM TIME
TO TIME
FROM ALLOWANCE
TO ALLOWANCE
WEEK OF
MONDAY
TUESDAY
WEDNESDAY
THURSDAY
FRIDAY
SATURDAY
SUNDAY
ISCI GROUP
DURATION
FLIGHT MATCHED (initially set to 0)
FLIGHT PURCHASED (initially set to 1)
FLIGHT ROW NUMBER
DETECTION I.D. (typically not populated at this point) (or,
DETECTION ROW NUMBER)

As described below, each record of the flight information table includes other fields for associating flight information to detections of broadcast advertisements. For example, the records of the flight information table include a DETECTION I.D. field which is used to associate flight records to detection records, as described further below.

If an agency revises an advertising buy order, the system compares the buy information already in the system with the new information and applies corrections to the tables as needed. This process may simply overwrite the records in the flight information table related to the same flight “estimate” within the date range specified in the revised buy information. Depending on the contents of the change, the change may also require the traffic information (i.e., the ISCI GROUP) to be reviewed and possibly reapplied to the new flight records.

Detections (Block 5 of the Example Process of FIG. 1)

Referring to FIG. 2, an example system for implementing the process of FIG. 1 comprises a plurality of electronic detection devices 10 located in distinct broadcast markets 14, 16, 18, 20, 22, 24 in a plurality of time zones (TZ1, TZ2, TZ3). The electronic detection devices 10 are configured to receive and analyze broadcasts on a number of channels of a number of broadcast mediums. Two or more detection devices 10 may receive signals from the same channel in the same market to provide redundancy and fault tolerance, in which case duplicative detection records from redundant detection devices 10 are preferably identified and/or removed later in the process. The detection records are collected at a central processing site 26 for analysis and reporting.

The detection devices 10 detect actual market broadcast instances of encoded broadcast items, such as encoded advertisements, and record information regarding each detected actual market broadcast instance, including a unique code for the device, a unique code for the detection event, and the date, time, channel, duration, and detected code or signature. The detection information is consolidated from the plurality of detection devices 10 at the central processing site 26, processed, and, as described further below, compared to expected broadcast occurrences specified by the flight information. Typically the following items are provided or can be derived from the reported detections.

DEVICE I.D.
DEVICE CHANNEL
ENCODED ISCI CODE (corresponding to the detected code and/or
signature)
DURATION
DATE AND TIME (reported in GMT and DST = N)
REPORTED CALL LETTER
MONITORED CHANNEL (e.g., frequency)
MEDIA TYPE

Detection information from each detection device 10 is initially enhanced at the central processing site 26 with certain reference information which is placed in the associated records of the detection table. The sources of the reference information used to initially enhance the detection information may include the monitoring device information, the channel information and the local broadcaster information, as well as the detected code, and the date and time of the detection. The values in the CALL LETTER field may be obtained from the split channel table based on the REPORTED CALL LETTER provided by the detection device at the time of detection. The MEDIA TYPE is set based upon whether the device is monitoring TV or Radio. The AGENCY ISCI CODE is obtained by performing a lookup in the encoded advertisement table using the ENCODED ISCI CODE. After initial enhancement, the following fields of the detection table are generally populated:

Initially Enhanced Detection Table

DEVICE I.D.
DETECTION I.D.
AGENCY ISCI CODE
ENCODED ISCI CODE (corresponding to the detected code and/or
signature)
DURATION
DATE AND TIME IN GMT
LOCAL DATE AND TIME
REPORTED CALL LETTER
CALL LETTER (may differ if split channel condition)
DEVICE MARKET
MEDIA TYPE (TV or Radio)
MARKET COMMON ROW

The DEVICE MARKET is obtained from the monitoring device table using the DEVICE I.D.

The detection information is enhanced further at the central processing site 26 with the program schedule information. By enriching the detection with schedule information the system does not need to maintain a large historical record of broadcast schedules. Only the current schedule needs to be in the system. The enhanced detection information provides a permanent record of what was playing when the detection was heard. The enhanced information is stored in an enhanced detection with schedule table, described below:

Enhanced Detection with Schedule Table

DETECTION I.D.
CALL LETTER
STATION TYPE
NATIONAL CALL LETTER
DISTRIBUTOR
BROADCAST MARKET
LOCAL DETECTED DATE AND TIME
SCHEDULED PROGRAM NAME
SCHEDULE ADJUSTMENT
SCHEDULE ADJUSTED DATE AND TIME
DETECTED DATE TM (in GMT DST-N)
SECONDS_INTO_PROGRAM
PROGRAM_STRING_ID (a combination of subtitle information, an
optional syndication indicator, and an optional episode indicator, as
described in greater detail below).

The table is populated by performing a series of look ups and time calculations based upon the adjustment values found in the schedule information tables. First the DETECTION I.D., CALL LETTER, MEDIA TYPE, LOCAL BROADCAST MARKET, LOCAL DATE AND TIME are brought over from the Initially Enhanced Detection table

If the example system of FIG. 2 is processing a cable station, the system looks up the ADJUSTMENT and FEED values from the National Cable Adjustment Table for that BROADCAST MARKET, CALL LETTER for the corresponding SEASONAL value. That adjustment value is applied to SCHEDULE ADJUSTED DATE AND TIME and the result is stored in a temporary datetime field. The system then performs a look up in the schedule table to determine what was playing on that National Cable network for the corresponding temporary datetime and national cable network and appropriate feed.

If the example system of FIG. 2 is working on a Broadcast detection, the individual schedule locally adjusted for that station is already in place in the schedule table. The system simply copies the LOCAL DETECTION DATE AND TIME into the temporary field and it then performs a look up in the schedule table to determine what was playing at that time on that CALL LETTER.

Once the example system of FIG. 2 has the corresponding schedule entry from the schedule table, the remaining fields are populated as follows. The system takes the PROGRAM NAME from the schedule table and places it in the SCHEDULED PROGRAM NAME in the detection record. The NATIONAL CALL LETTER and DISTRIBUTOR are also copied from the schedule table to the corresponding fields in the detection record. The pre-calculated schedule adjustment value from the schedule table is preferably multiplied by −1 and is applied to the temporary datetime field, which is then placed in to the SCHEDULE ADJUSTED DATE AND TIME field. The resulting sum of adjustments (if any) which were used to adjust the time is stored in the SCHEDULE ADJUSTMENT field. Preferably, the record is also enhanced with an adjustment to relate the local date and time to the base time zone (in absolute terms).

The detection information is also enhanced at the central processing site 26 with the encoded advertisements information and the agency commercial information. Specifically, the DETECTED CODE of each detection record is used to perform a look-up in the encoded advertisements table to obtain the associated AGENCY ISCI CODE, which may be placed in an AGENCY ISCI CODE field in the associated detection record. In addition, the MULTI-MARKET BROADCAST associated with the AGENCY ISCI CODE is obtained from the encoded advertisement table with a look-up based on the AGENCY ISCI CODE. The AGENCY-CLIENT-BRAND-PRODUCT associated with the AGENCY ISCI CODE may be obtained from the agency commercial table with a look-up based on the AGENCY ISCI CODE and LOCAL DATE.

Once the enhanced detection schedule record has been completed, the example system of FIG. 2 undertakes a process to review all the new records and to generate a detection table having all of the unique detections within a given market. The example system identifies redundant detections within the same market having the same call letter and time. Redundant detections may be linked together with a common MARKET COMMON ROW value, or the redundant detection records can be deleted. Then, the system builds a processed detection table having a detection record for each unique MARKET COMMON ROW and that contains a combination of all the data associated with the detection. The processed detection record is described below.

Processed Detection Table

DETECTION I.D.
AGENCY ISCI CODE
CALL LETTER
NATIONAL CALL LETTER
DISTRIBUTOR
AGENCY
CLIENT
BRAND
PRODUCT
DEVICE MARKET
BROADCAST MARKET
DETECTED DURATION
DEVICE I.D.
SCHEDULED PROGRAM NAME
DAY PART
TIME ZONE
STATION TYPE
MEDIA TYPE
FLIGHT ROW
ENCODED ISCI CODE (corresponding to the detected code and/or
signature)
TYPE OF DETECTION
NATIONAL COMMON ROW
NATIONAL MARKET COUNT
NATIONAL MARKET MINIMUM
BROADCAST DAY DETECTED DATE AND TIME
SCHEDULE ADJUSTED DETECTED DATE AND TIME
ADJUSTED FEED DETECTED DATE AND TIME
DETECTED DATE AND TIME (GMT DST = N)

The record is built from information contained in previously discussed tables, and some additional enrichment from other reference tables.

The following fields are populated from the corresponding record in the initially enhanced detection table: DETECTION I.D., AGENCY ISCI CODE, DEVICE MARKET, DURATION, DEVICE I.D., MEDIA TYPE.

The following fields are populated from the enhanced detections with schedule table: CALL LETTER, DISTRIBUTOR, NATIONAL CALL LETTER (from DISTRIBUTOR), SCHEDULED PROGRAM NAME, SCHEDULED PROGRAM NAME, SCHEDULE ADJUSTMENT, SCHEDULE ADJUSTED DATE AND TIME, DETECTED DATE TM (in GMT DST-N), SECONDS_INTO_PROGRAM, PROGRAM_STRING_ID (a combination field, as described in greater detail below). The BROADCAST DETECTED DATE AND TIME field is derived from the LOCAL DETECTED DATE AND TIME with an adjustment. In an example implementation, the adjustment provides that any detection which occurred between Midnight and 4:59:59 AM will have 1 day subtracted from the date field. For example, on a Friday night TV schedule an example show may run from 12:37 AM to 1:37 AM EST, such that the airing of the show actually occurs on Saturday, although the show is to be associated with the Friday night TV schedule. Thus, to account for actual date changes for late night programming, for 5 hours after midnight the date is adjusted by subtracting 1 day to associate the late night programming with the previous day.

The STATION TYPE comes from the call letter translation table based on the CALL LETTER included in the detection (for example, WABC is type=TV and ESPN is type=CTV).

The AGENCY-CLIENT-BRAND-PRODUCT combination is obtained from the agency commercial table using the AGENCY ISCI CODE, DETECTED DATE AND TIME (GMT) of the detection.

The BROADCAST MARKET comes from a lookup in the call letter translation table using the CALL LETTER.

The TIME ZONE is from a lookup on the location of the monitoring device. The FLIGHT ROW is initially set to a predetermined value (e.g., −1) to indicate it has not been associated with any flight records. The TYPE OF DETECTION is set to a predetermined value (e.g., a value of “X”). The NATIONAL MARKET COUNT and NATIONAL MARKET MINIMUM are initially set to zero. The NATIONAL COMMON ROW is initially set to a first predetermined value (e.g., −1) if the commercial is intended to be national in scope, or a second predetermined value (e.g., −2) if it is local. The detection is further enriched with a day part label by looking up the DAY PART (e.g., MORNING, DAYTIME, PRIMETIME, EVENING, LATE, OVERNIGHT) to which this detection corresponds. This information may be held in a day part reference table.

Associate Related National Detection Records (Block 6 of the example process of FIG. 1)

Using different methods, multiple attempts are made to associate detection records obtained for different markets that together correspond with, for example, a common multi-market (e.g., national) commercial order and the subsequent broadcasting of the commercial. Individual market-level detections that can be associated with each other are referred to as “multi-market detections” or “national detections” of a multi-market broadcast in the following description. These associations normally correspond to the program schedule. On occasion they correspond to a live event, which may go beyond a scheduled time. For example, a World Series game may go into extra innings, or a regional football game may run later than its counterparts. As a result, the system makes multiple attempts using different methods to associate national detections together. Proxy, or synthetic, anchor detection records are created and used to represent the association of individual market-level detections that correspond to multi-market (or national) detections of a multi-market broadcast.

For example, the example system of FIG. 2 reviews the unassigned market level detections corresponding to a national commercial. The system attempts to determine if there are any existing multi-market (e.g., national) associations with which a particular market-level detection could be associated. To demonstrate the association of market-level detections into multi-market (e.g., national) detections, assume that this is the first day a National airing of a commercial is aired and, thus, there are no previously built national records for this commercial.

The example system of FIG. 2 reviews each of the unassigned market level detections for this national commercial. It queries the data using the four different methods discussed in greater detail below, counting the number of markets/stations which match each method's selection criteria. The example system of FIG. 2 then builds a National Association using the method that scores the most detections.

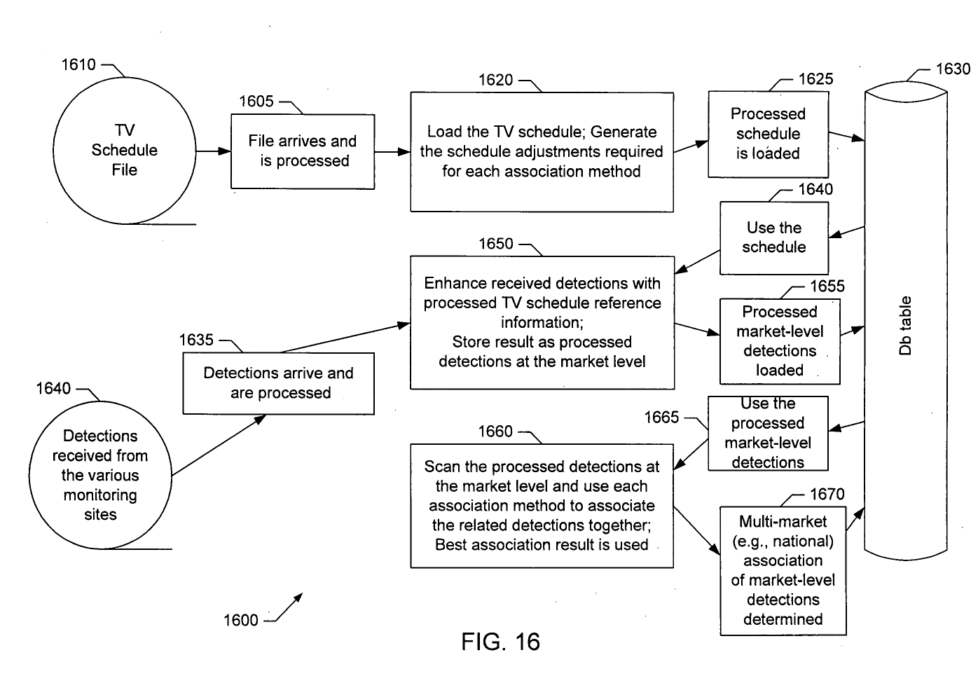

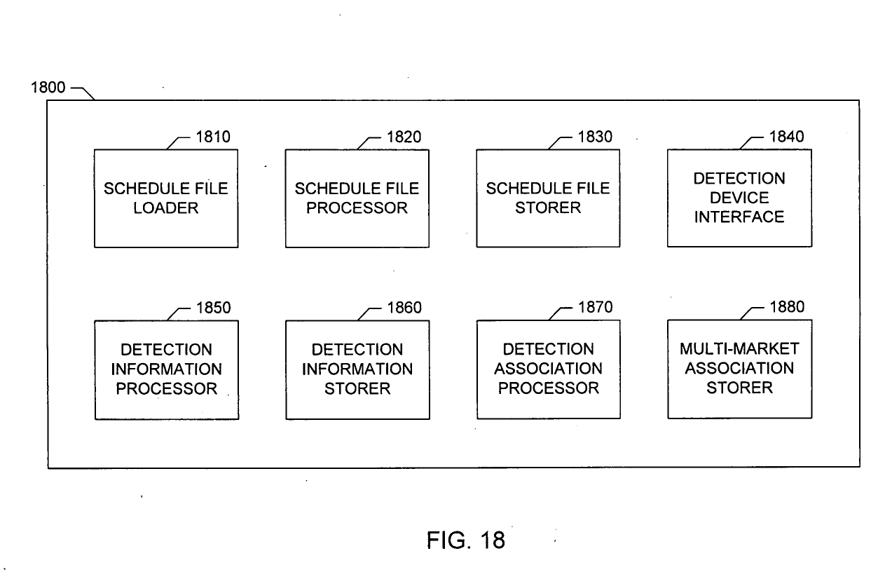

A flowchart representative of an example process 1600 for associating market-level detections together into multi-market (e.g., national) detections corresponding to a multi-market broadcast is illustrated in FIG. 16. The example process 1600 of FIG. 16 may be executed to implement at least portions of an example record association apparatus 1800 illustrated in FIG. 18. In an example implementation, the record association apparatus 1800 is included in the example central processing site 26 of FIG. 2 to associate records corresponding to market-level detections together into multi-market (e.g., national) detections corresponding to a multi-market broadcast.

The example process 1600 uses the following four methods to attempt to associate national records together: the schedule method (i.e., association based on schedule criteria), the network method (i.e., association based on network criteria), the episode method (i.e., association based on episode criteria) and the feed method (i.e., association based on feed criteria). These four methods are discussed in greater detail below. With reference to the example record association apparatus 1800 of FIG. 18, the example process 1600 of FIG. 16 begins execution at block 1605 at which an example schedule file loader 1810 included in the example record association apparatus 1800 loads schedule files 1610 corresponding to the markets being monitored. The schedule files 1610 include the program schedule table information described above for each of the monitored markets. Next, at block 1620 an example schedule file processor 1820 included in the example record association apparatus 1800 processes the loaded schedule files to generate any schedule adjustments needed by the methods for associating market-level records together. Such schedule adjustments may include, for example, common day and/or time adjustments to be used to relate the date and time of different received national detections to a particular base market. Then, at block 1625 a schedule file storer 1830 included in the example record association apparatus 1800 stores the schedule files and processed schedule adjustments in a database 1630 for subsequent processing.

Next, at block 1635 an example detection device interface 1840 included in the example record association apparatus 1800 receives the unprocessed detection events (e.g., detection information) 1640 from the detection devices 10 at the monitoring sites. Next, at block 1640 an example detection information processor 1850 included in the example record association apparatus 1800 retrieves the schedule files and schedule adjustments stored in the database 1630. Then, at block 1650 the example detection information processor 1850 processes the received detections with the schedule information and schedule adjustments retrieved from the database 1630. The result of processing at block 1650 is a set of detection records corresponding to the received detection events. Each detection record may include, for example, the information in the enhanced detection with schedule table described above. Then, at block 1655 an example detection information storer 1860 stores the detection records in the database 1630.

Next, at block 1660 an example detection association processor 1870 included in the example record association apparatus 1800 processes the detection records stored in the database 1630 to associate market-level records together. The detection records stored in the database 1630 are retrieved by the example detection association processor 1870 at block 1665. For example, at block 1660 the example detection association processor 1870 may process the detection records using some or all of the schedule method, the network method, the episode method and/or the feed method to attempt to associate the detection records together as multi-market (e.g., national) detection records corresponding to a common multi-market (e.g., national) broadcast. In an example implementation, the process example detection association processor 1870 compares the association results for each of the methods and selects a final national record association (e.g., represented using a synthetic anchor detection record containing information representative of the association of market-level detections) that yields a grouping in which a particular common multi-market (e.g., national) broadcast can be associated with the largest number of other market records (e.g., the largest number of detection records determined to be associated with the particular national broadcast). Additionally, at block 1660 the example detection association processor 1870 determines national anchor detection records for each of the determined national record associations. As mentioned previously, in an example implementation, each national anchor detection record functions as a proxy record used to represent the association of all of the corresponding national records. The national anchor detection records may be used in subsequent processing to compare, for example, actual broadcast detections to original multi-market orders, etc. Then, at block 1670 an example multi-market association storer 1880 included in the example record association apparatus 1800 stores the resulting national record associations and/or national anchor detection records in the database 1630.

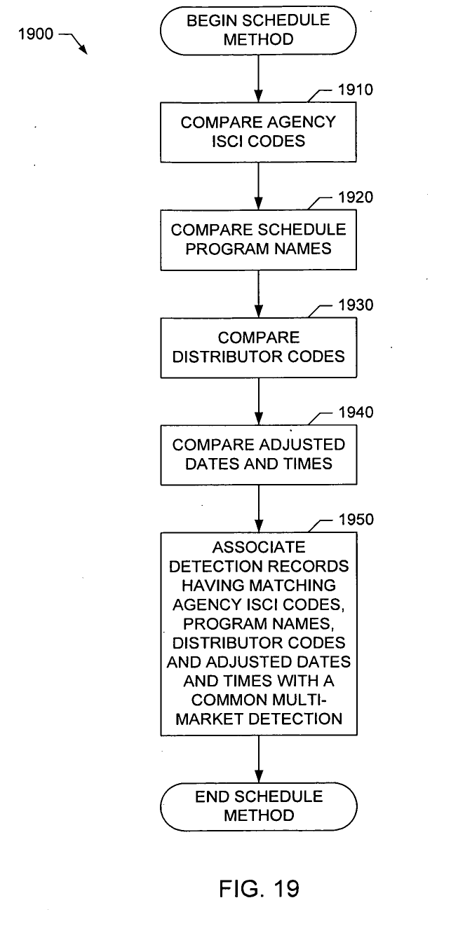

Each of the four possible methods mentioned above which may be used to attempt to associate national records together is now described in greater detail with reference to the example flowcharts illustrated in FIGS. 19-22. The example processes represented by the example flowcharts illustrated in FIGS. 19-22 may be used to implement some or all of the processing performed by the example detection association processor 1870 of FIG. 18 at block 1660 of the example process 1600 of FIG. 16.

First Method: Review of Markets Using the Schedule Method to Generate National Anchors

As discussed above, using the pre calculated schedule adjustments in the reference data included in the TV Schedule, each detection was supplemented with schedule information and the corresponding calculated adjustments. A flowchart representative of an example process 1900 implementing the schedule method is illustrated in FIG. 19 and, when executed, allows the example detection association processor 1870 of FIG. 18 to look across the country for detections having the same DIST CODE, adjusted date and time range and a common ISCI code. If there were multiple airings in a market, the schedule adjustment provides the corresponding adjustment to the projected base market.

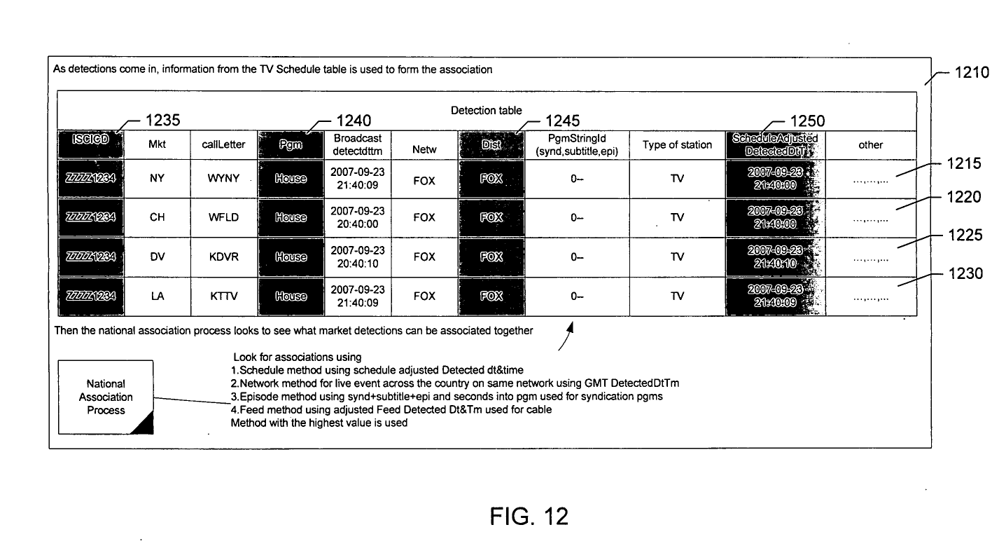

For illustration, an example detection table 1210 for use by the example schedule method process 1900 is shown in FIG. 12. The example detection table 1210 includes detection entries 1215-1230 corresponding to detection records from different markets. The example detection table 1210 also includes a column 1235 of agency ISCI codes, a column 1240 of program names, a column 1245 of distributor codes and a column 1250 of adjusted date and times generated for each detection entry 1215-1230 for use by the example schedule method process 1900. In the illustrated example of FIG. 19, the example schedule method process 1900 implemented by the example detection association processor 1870 compares at blocks 1910, 1920, 1930 and 1940, respectively, the column 1235 of agency ISCI codes, the column 1240 of program names, the column 1245 of distributor codes and the column 1250 of adjusted date and times generated for each detection entry 1215-1230. Then, at block 1950 the example detection association processor 1870 is able to use the results of comparing the columns 1235-1250 to determine that the detections corresponding to the table entries 1215-2530 may be associated to the same multi-market episode airing and, thus, to the same anchor detection record.

Second Method: Review of Markets Using the Network Method to Generate National Anchors

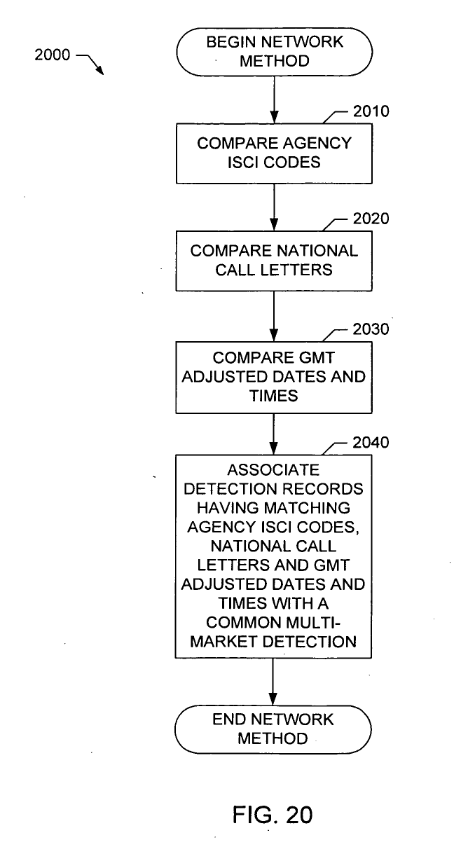

In the network method, the example system of FIG. 2 further attempts to associate individual market-level detection records together as corresponding to a multi-market (e.g., national) commercial broadcast. A flowchart representative of an example process 2000 implementing the network method is illustrated in FIG. 20 and, when executed, allows the example detection association processor 1870 of FIG. 18 to look to see if these detections correspond to a live event running out-of-schedule on the network affiliates. Using the example network method process 2000, the example detection association processor 1870 compares the NETWORK, the DETECTED DATE and TIME (GMT DST=N) and ISCI code. As before, the example detection association processor 1870 looks to associate unassigned market records with national records which have not had that market associated with it.

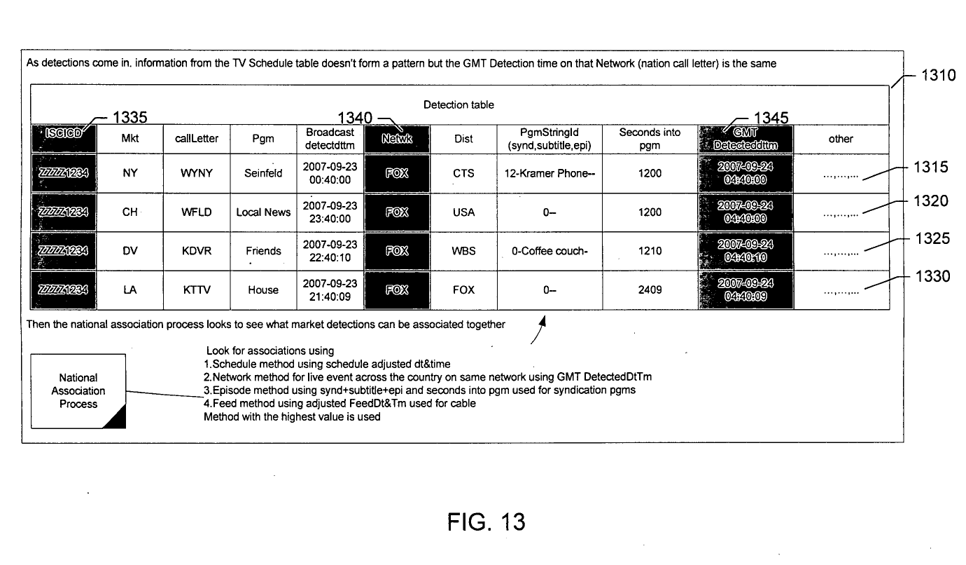

For illustration, an example detection table 1310 for use by the example network method process 2000 is shown in FIG. 13. The example detection table 1310 includes detection entries 1315-1330 corresponding to detection records from different markets. The example detection table 1310 also includes a column 1335 of agency ISCI codes, a column 1340 of network call letters, and a column 1345 of detected dates and times adjusted to a base market corresponding to GMT time generated for each detection entry 1315-1330 for use by the example network method process 2000. In the illustrated example of FIG. 20, the example network method process 2000 implemented by the example detection association processor 1870 compares at blocks 2010, 2020 and 2040, respectively, the column 1335 of agency ISCI codes, the column 1340 of network call letters, and a column 1345 of adjusted GMT dates and times generated for each detection entry 1315-1330. Then, at block 2040 the example detection association processor 1870 is able to use the results of comparing the columns 1335-1345 to determine that the detections corresponding to the table entries 1215-1230 may be associated to the same multi-market episode airing and, thus, to the same anchor detection record.

Third Method: Review of All Markets Using Episode Method to Generate National Anchors

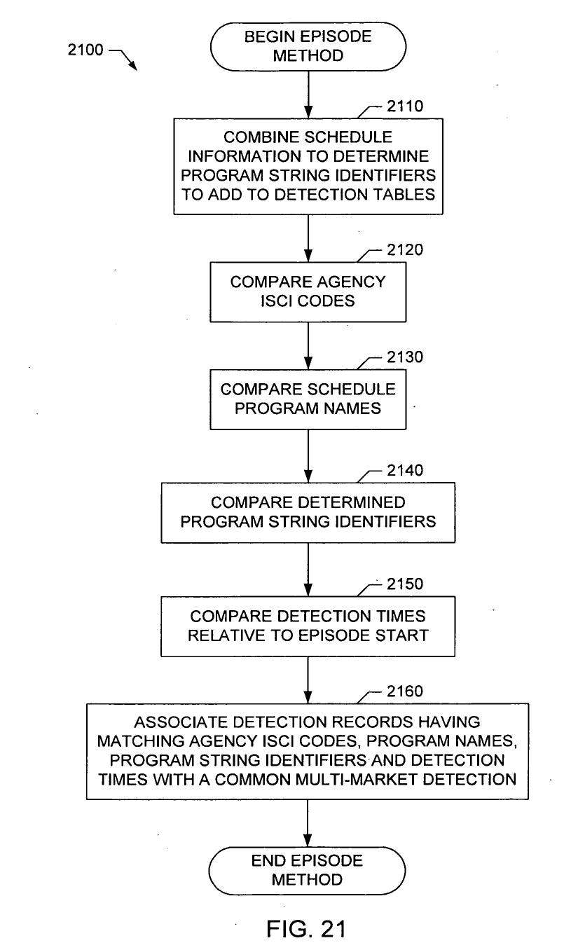

A flowchart representative of an example process 2100 for execution by the example detection association processor 1870 of FIG. 18 to implement the episode method is illustrated in FIG. 21. The episode method is a third method in which the example detection association processor 1870 attempts to associate market-level detection records together as corresponding to a multi-market (e.g., national) commercial broadcast. Like the schedule method, the episode method also utilizes program schedules as the basis for associating multi-market detection records together. However, unlike the schedule method, the episode method uses additional program information provided in the program schedule to correlate detection records across multiple markets, if such information is available. For example, in addition to the PROGRAM NAME which is included in the program schedule table as discussed above, some broadcasters also include a program subtitle (PROGRAM SUBTITLE), syndicator indicator (SYNDICATOR) and/or episode name (EPISODE NAME) in their program schedules. Also, some Syndicated programs are not broadcast in all markets on the same day. Therefore, this method examines detections across multiple days (with the number of days being configurable) as compared to the other methods which search for a common broadcast date. If this additional information is available in the program schedule, the episode method may provide more accurate multi-market detection associations under some circumstances.

For example, for programs in syndication, multiple episodes of the same program (e.g., “show”) may be aired in different markets (e.g., New York and Chicago). Furthermore, different episodes of the same syndicated show may be aired at different times, and even in different episode order. For example, both a New York broadcaster and a Chicago broadcaster may be scheduled to air two episodes of the show “Everybody Loves Raymond” on the same day. However, the Chicago broadcaster may air the episodes in reverse order as compared with the New York broadcaster. Because the episode method allows detections to be correlated based on episode information, detections corresponding to the first episode aired in Chicago can be associated with detections corresponding to the second episode aired in New York, and vice versa. The episode method also allows for associations between a market in which only one episode is aired and a market in which multiple episodes are aired.

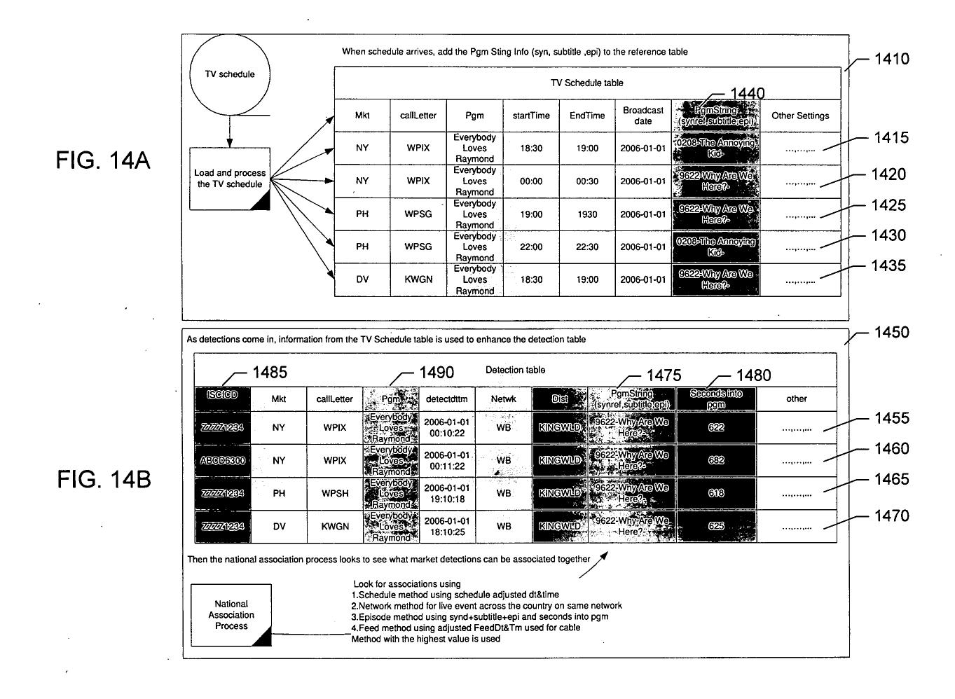

An example schedule table 1410 for use by the example episode method process 2100 and that includes additional program identification information is illustrated in FIG. 14A. In the illustrated example, each entry 1415-1435 of the schedule table corresponds to a particular program in a particular market. As shown, the schedule table 1410 includes a column of additional information 1440 that includes PROGRAM SUBTITLE, SYNDICATOR and/or EPISODE NAME information for each table entry. The additional information 1440 may be used by the example episode method process 2100 to correlate particular episodes of particular programs across different markets. For example, the additional information 1440 in the schedule table 1410 indicates that the entry 1415 for the program “Everybody Loves Raymond” aired in New York corresponds to the entry 1430 for the program “Everybody Loves Raymond” aired in Philadelphia, whereas the entry 1420 for the program “Everybody Loves Raymond” aired in New York corresponds to the entry 1425 for the program “Everybody Loves Raymond” aired in Philadelphia.

To associate multi-market detection records, at block 2110 the example episode method process 2100 implemented by the example detection association processor 1870 combines the available PROGRAM SUBTITLE, SYNDICATOR and/or EPISODE NAME information into a PROGRAM_STRING_ID which is added to the detection tables. The example detection association processor 1870 then scans across the detection records for the monitored markets and associates those records having the same ISCI CODE, PROGRAM_STRING_ID and DISTRIBUTOR, and for which the detection occurred at the same time (e.g., within a window of time) into the airing of the particular program episode. For illustration, an example detection table 1450 for use by the example episode method process 2100 is shown in FIG. 14B. The example detection table 1450 includes detection entries 1455-1470 corresponding to detection records from different markets. The example detection table 1450 also includes a column of PROGRAM_STRING_ID information 1475 generated for each detection entry 1455-1470 by the processing at block 2110 of the example episode method process 2100. The example detection table 1450 further includes a column of detection time information 1480 specifying at what time the detection occurred during the airing of each episode (e.g., at what time from the start of the each episode the detection occurred). In the illustrated example of FIG. 21, the example episode method process 2100 implemented by the example detection association processor 1870 compares at blocks 2120, 2130, 2140 and 2150, respectively, the column 1485 of agency ISCI codes, the column 1490 of program names, the column 1475 of determined PROGRAM_STRING_ID information and the column 1480 of detection time information generated for each detection entry 1215-1230. Then, at block 2160 the example detection association processor 1870 is able to use the results of comparing the PROGRAM_STRING_ID information 1475 and detection time information 1480 (as well as the ISCI CODE and DISTRIBUTOR information) to determine that the detections corresponding to the table entries 1455, 1465 and 1470 may be associated to the same multi-market episode airing and, thus, to the same anchor detection record.

Fourth Method: Review of All Markets Using Feed Method to Generate National Anchors

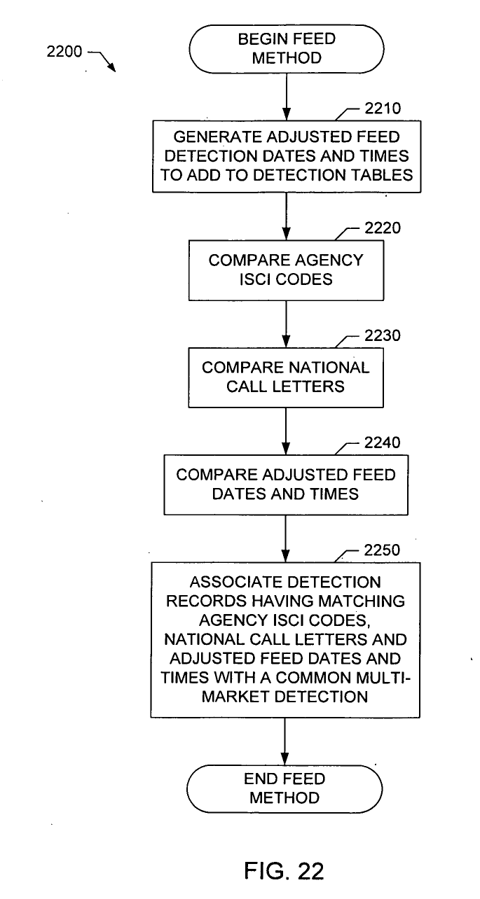

A flowchart representative of an example process 2200 implementing the feed method is illustrated in FIG. 22 and, when executed, implements is a fourth method which allows the example detection association processor 1870 of FIG. 18 to attempt to associate market-level detection records together as corresponding to a multi-market (e.g., national) commercial broadcast. The feed method is applicable to associating records, for example, between markets which are served by different broadcast feeds (e.g., different satellite feeds), such as, for example, an east coast feed and a west coast feed. For example, if a U.S. cable network is broadcast on dual east coast and west coast feeds, there will be a three-hour time difference between when a commercial is added on the east coast feed vs. the west coast feed. In the illustrated example of FIG. 22, at block 2210 the example feed method process 2200 augments the detection tables with an ADJUSTED FEED DETECTION DATE & TIME FIELD which adjusts for the time difference between the broadcasts of different feeds. This timing adjustment allows the feed method to associate multi-market (e.g. national) detection records across different broadcast feeds.

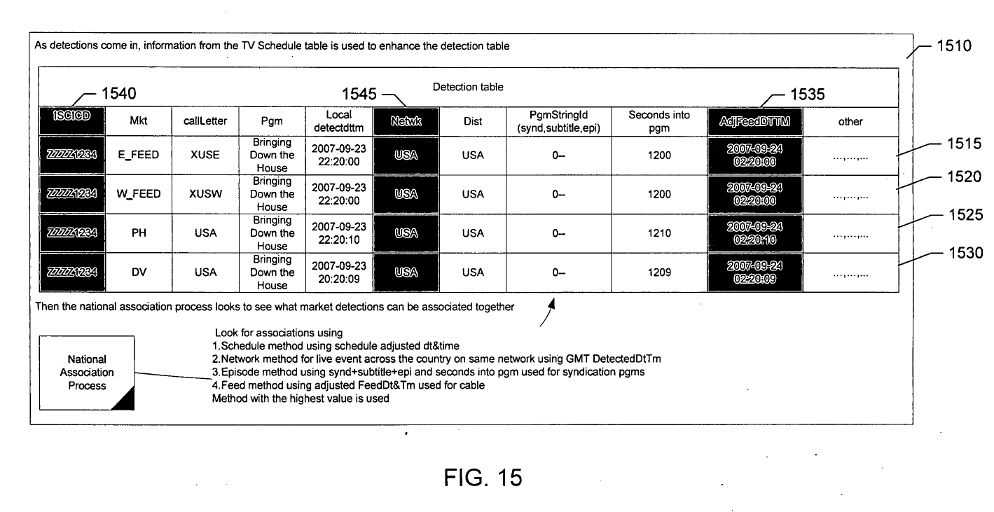

For illustration, an example detection table 1510 for use by the example feed method process 2200 is shown in FIG. 15. The example detection table 1510 includes detection entries 1515-1530 corresponding to detection records from different markets and/or different broadcast feeds. The example detection table 1510 also includes a column 1535 of ADJUSTED FEED DETECTION DATE & TIME FIELD information generated for each detection entry 1515-1530 by the processing at block 2210 of the example feed method process 2200. In the illustrated example of FIG. 22, the example feed method process 2200 implemented by the example detection association processor 1870 compares at blocks 2220, 2230 and 2240, respectively, the column 1540 of agency ISCI codes, the column 1545 of network call letters, and the columns 1535 of ADJUSTED FEED DETECTION DATE & TIME FIELD information generated for each detection entry 1515-1530. Then, at block 2250 the example detection association processor 1870 is able to use the results of comparing the ADJUSTED FEED DETECTION DATE & TIME FIELD information 1535 (as well as the ISCI CODE and network call letter information) to determine that the detections corresponding to the table entries 1515-1530 may be associated to the same multi-market episode airing (even though broadcast on different feeds) and, thus, to the same anchor detection record.

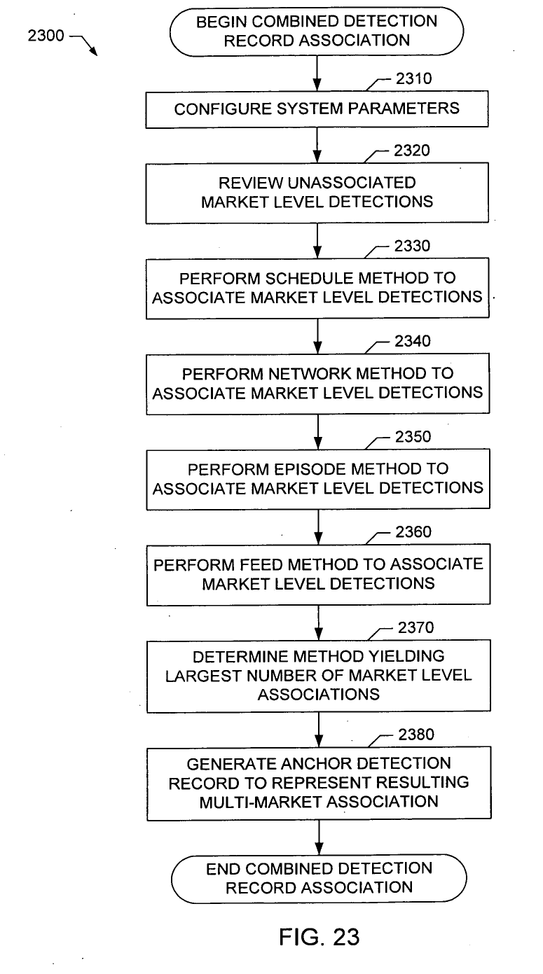

As discussed above in connection with FIG. 16, some or all of the schedule, network, episode, and/or feed methods described above may be used to attempt to associate multi-market (e.g., national) records together. A flowchart representative of an example process 2300 implementing a detection record association process combining the schedule, network, episode and feed methods to associate different individual market-level detections together into multi-market (e.g., national) broadcast detections is illustrated in FIG. 23. In the illustrated example, each method (as appropriate) is used to attempt to associate market detection records with corresponding anchor detection records. Each anchor detection record represents a particular multi-market (e.g., national) detected broadcast. The number of market detection records associated with a particular anchor detection record is stored as a count value in the anchor detection record. Then, the anchor detection records resulting from each method's attempt to associate market detection records are compared. The anchor detection records for the method returning the highest counts for the number of associated market record detections, provided these numbers exceed one or more specified threshold values, are then deemed to be the actual anchor detection records. The actual multi-market (e.g., national) detection associations corresponding to the selected anchor detection record(s) are then used in subsequent analyses of the detection results.

In an example operation, execution of the example process 2300 begins at block 2310 at which the example system of FIG. 2 (or in a particular example implementation, the example detection association processor 1870 of FIG. 18) is configured with the following run time parameters:

Time association interval,

Minimum number of detections for a qualified national broadcast detection

Minimum number of detections for a qualified national syndication detection

Minimum number of detections for a qualified national cable detection

For records to be considered qualified national records, the number of market/station detections which are associated need to either meet or exceed the minimum number(s) specified above, as appropriate.

In the example operation, the example system of FIG. 2 (or in a particular example implementation, the example detection association processor 1870 of FIG. 18) starts reviewing all of the unassociated national detections on a market by market basis at block 2320. The markets are reviewed in the sequence defined in the market table. All unassociated national detections include a −1 in the NATIONALCOMMON ROW field. For each unassigned national detection, the system pulls information from the unassigned market record on which to base its search. For example, the information may include the ISCI CODE, Network, DIST CODE, different date and times, the type of station, etc.

Next, at block 2330 the schedule method (e.g., as implemented by the example detection association processor 1870) looks for associations using multiple fields. There is a slight difference in the query depending upon whether the detection occurs during a syndicated show or not. The system looks across the country for other unassigned market records with a NATIONAL COMMON ROW of −1 and the ISCI CODE equal to the value from the unassigned detection being processed. The system also determines whether the DIST_CODE from each of these other unassigned market records is equal to the value from the unassigned detection undergoing processing and whether the SCHEDULE ADJUSTED DTTM occurs within a specified +/−(interval). If the detections are believed to be on a syndicated TV show, the SCHEDULE PGM NAME field is added to the query. The system queries the detection table and gets a count of the number of similar unassigned detections that could be associated together. Each unique market/station combination can be counted only once. This information is stored in the ScheduleCount field.

Next, at block 2340 the example system of FIG. 2 (or in a particular example implantation, the example detection association processor 1870) uses the network method to look for network events (e.g., live events) across the country which may not correspond to a schedule. The example system of FIG. 2 again looks across the country for other unassigned market records. The example system prepares another selection query to determine how many individual stations can be associated with this query. The query comprises looking for records in which the NATIONAL COMMON ROW is −1, the ISCI CODE is equal to the value from the unassigned detection, the NETWORK is equal to the value from the unassigned detection, and the DETECTED DATE and TIME (GMT DST=N) occurs within +/−(interval). The system queries the detection table and gets a count of the number of similar unassigned detections that could be associated together. Each unique market/station combination can be counted only once. This information is stored in the NetworkCount field.

Next, at block 2350 the example system of FIG. 2 (or in a particular example implantation, the example detection association processor 1870) uses the episode method to look for episodes using the sub title approach. If the PROGRAM_STRING_ID (e.g., the combination field described above) is not populated with the default value 0, then this method is also used. The example system of FIG. 2 again looks across the country for other unassigned market records. The application prepares another selection query to determine how many individual stations can be associated with this query. The query comprises looking for records where the NATIONAL COMMON ROW is −1, the ISCI CODE is equal to the value from the unassigned detection, the DIST_CODE is equal to the value from the unassigned detection, and the PROGRAM-NAME, PROGRAM STRING ID, SECONDS INTO THE PROGRAM+/−(interval) match over a +/−3 day period of DETECTED DATE AND TIME (GMT DST=Y). The example system of FIG. 2 queries the detection table and gets a count of the number of similar unassigned detections that could be associated together. Each unique market/station combination can be counted only once. This information is stored in the EpisodeCount field.

Next, at block 2360, if the example system of FIG. 2 is configured to examine cable and/or satellite markets, it will use the feed method to look across the detection set using the AdjustedFeed approach. The example system of FIG. 2 again looks across the country for other unassigned market records. The application prepares another selection query to determine how many individual stations can be associated with this query. The query comprises looking for records where the NATIONAL COMMON ROW is −1, the ISCI CODE is equal to the value from the unassigned detection, the NETWORK is equal to the value from the unassigned detection and the ADJUSTED FEED DETECTED DATE and TIME occurs within the specified +/−(interval). The example system of FIG. 2 queries the detection table and gets a count of the number of similar unassigned detections that could be associated together. Each unique market/station combination can be counted only once. This information is stored in the FeedCount field.

The system then at block 2370 looks at the results stored in each of the four (4) counter fields, namely, ScheduleCount, NetworkCount, EpisodeCount, FeedCount. The method associated with the largest value is chosen as the method to generate a national association. The system also at block 2370 uses the associated selection criteria which yielded the highest count. For example, assume that the schedule method associated 130 detections, the Network method associated 55 detections, the episode associated 92 detections, and the feed method associated 78 detections. In this example, the system would use the schedule method which had the largest association value.

The unassigned market detection is then used to generate the synthetic base or anchor detection record at block 2380. The information from the market detection record is copied into the anchor detection record with the following exceptions.

The MARKET field is set to National.

The NATIONALMKTCOUNT is set to the count field of the chosen method.

If the DISTCODE is different than the NETWORK, the method chosen is either the Episode or Schedule method and the STATION TYPE is TV, then the STATION TYPE is changed to STV

If the method used is the Network or Feed method, the NETWORK value is placed in the DETECTED CALL LETTER field; otherwise the DISTCODE is placed in the DETECTED CALL LETTER field.

If the method used is the Feed method, the NATIONALMKTMIN field is set to 1; otherwise the NATIONALMKTMIN field is set to the runtime value specified for that type of detection.

The TYPE OF DETECTION is set to S (for schedule), N (for network), E (for episode), or F (for feed) depending on the method selected to make the association.

Once the anchor detection record is built, that record and all of the individual market-level records which meet the selection criteria are tied together by placing the DETECTION ID in the NATIONALCOMMON ROW field for all of those records, thereby linking all the detections together.

The system continues processing all of the remaining unassociated National detection(s) in the same manner as described above.

In some example implementations, the system will examine detections for the subsequent day (e.g., Day 2) to see if any of the newly discovered unassigned market detections can be associated with the previously built national detections. If, for example, on the current day (e.g., Day 1) national detections of the S type (i.e., schedule type) were built and the markets of Albany and Boston were not associated on Day 1, the system on Day 2 will look to see if there are any unassigned market detections in Albany and Boston which, using a Schedule query, would fill in the market gap. If such market detections are found, these records are added to the national detection(s) by setting the national common row of the market record(s) to the national common row of the national record to which we are linking the record(s). Also the corresponding NATIONALMKTCOUNT is incremented with each additional market. Once the link review of the previous day's national records is complete the system will look to build new national records as described above. Also, it is possible that, when examining the various market level detections determined using the different methods and for a specific time association window, more than one market level detection for a particular station in a particular market may appear to be associated to the same national record. When this occurs, the example system of FIG. 2 determines which of those multiple detections for that particular station is the closest in time to the time of the national anchor record and associates the closet multiple record with this national record.

The result of the process of associating related market detections is a processed detection table having four types of records: (1) qualified synthetic anchor detection records associated to at least the predetermined minimum number of actual detection records with the BROADCAST MARKET=“NATL”, (2) unqualified synthetic anchor detection records associated to less then the minimum number of actual detection records with the BROADCAST MARKET=“NATL”, (3) actual detection records associated with anchor detection records of Type 1 or 2, and (4) actual detection records not associated with anchor detection records. The records of Type (2) may be considered “local anomalies” of detections of multi-market advertisements. The records of Type (4) are detections of single-market or “spot” advertisements.

Associating Detections to Flights (Block 7 of the Example Process of FIG. 1)

As described above, the flight information may be either national in scope (i.e., multi-market) or focused on a specific (single) market. As a result, the CALL LETTER and BROADCAST MARKET fields have been set accordingly and indicate whether the record is related to a multi-market or single-market advertising order. For example, a record for a national flight could have “ABC” as the CALL LETTER and “NATL” as the BROADCAST MARKET. On the other hand, if the flight is focused on the New York market, the CALL LETTER could be “WABC” and the BROADCAST MARKET could be “NY.”

On the detection record side, the anchor detection records (e.g., with a BROADCAST MARKET of “NATL” (either Type 1 or 2 from above) have been generated from the individual actual detection records for multi-market (e.g., national) advertisements. The anchor detection records are either qualified or non-qualified (i.e., “local anomalies”). In either case, the individual actual detection records for the multi-market advertisements (Type 3 from above) have been associated to an anchor detection record and to themselves via a common value in the NATIONAL COMMON ROW field. The type 4 actual detection records are single-market (i.e., non-national) market records.

Direct Match: Previously unassociated (or unmatched) qualified anchor detection records (Type 1) and single-market actual detection records (Type 4) are compared with unassociated (unmatched) multi-market flight information table records and single-market flight information table records, respectively. As described above, the flight information table records relate to line item details in the buy information.

The system checks each unassociated flight record to see if a corresponding unassociated detection record exists which completely satisfies the criteria of the flight record. A detection record will completely satisfy the criteria of the flight record when: (1) the AGENCY, CLIENT, BRAND, PRODUCT, BROADCAST MARKET, CALL LETTER and DURATION/LENGTH OF SPOT fields of the detection and flight records are the same, (2) the ISCI CODE of the detection record is within the ISCI GROUP of the flight record, (3) the BROADCAST DAY DETECTED DATE AND TIME of the detection is within the START and END dates of the FLIGHT record, (4) the day of the week of the detection record matches an allowable day of the week of the flight record (i.e., one of the MONDAY, TUESDAY, WEDNESDAY, THURSDAY, FRIDAY, SATURDAY or SUNDAY fields), and (5) the LOCAL TIME of the detection record is within the START TIME and END TIME of the flight record. Further, if the records being compared are related to a syndicated program, the SCHEDULED PROGRAM NAME fields of the detection record and the flight record must match.

When a match is found, the flight and detections records are updated to associate each with the other (FIG. 1, block 7). Specifically, the DETECTION I.D. field of the flight record is updated to contain the DETECTION I.D. of the corresponding detection record, and the FLIGHT ROW field of the detection record is updated to contain the row (e.g., record number) of the corresponding flight record. Furthermore, if the detection record is an anchor detection record, then the FLIGHT ROW fields of all of the actual detection records associated with the anchor detection record (i.e., all which share the same NATIONAL COMMON ROW value) are updated to contain the row of the corresponding flight record. As described below, these associations allow for detailed (drill-down) reporting, and takes the associated records out of the pool of unassociated records.

In addition, a FLIGHT MATCHED field of the flight record may be set (e.g., to “1” or “YES”) to indicate that the flight is associated with a detection record.

Preferably, flight records are compared in a predetermined order to optimize matching accuracy. For example, prior to or during matching, the flight records may be sorted. Primarily, the flight records may be sorted by a time window specified in the fight record, which may be held in a TIME WINDOW field in the flight record. The time window is the difference between the FROM TIME and the TO TIME of the flight record. Secondarily, the flight records may be sorted by the size of the ISCI GROUP, which may be ascertained by determining the length of the field (e.g., the number of characters), or by any other suitable manner. A tertiary sort of the flight records may be made based on the ITEM NUMBER field, where 1 of N would precede N of N.

Secondary Comparisons: Once the direct matching process discussed above has been performed, a series of secondary comparisons are made for imprecise matches with one or more parameters. These secondary comparisons are set forth in a preferred order. However, other orders may be suitable. As above, in the secondary comparisons, previously unassociated (or unmatched) qualified anchor detection records (Type 1) and single-market actual detection records (Type 4) are compared with unassociated (unmatched) multi-market flight information table records and single-market flight information table records, respectively.

Match With a Primary Time Allowance: In an example secondary comparison, detection records are compared to unassociated flight records in a manner similar to the manner described above with respect to direct matches. However, in this instance, a predetermined primary time allowance is provided, which has the effect of decreasing the FROM TIME and increasing the TO TIME of the flight record by the primary time allowance. For this comparison, the FROM ALLOWANCE and TO ALLOWANCE fields of the flight record may be employed.

If a match is found in this comparison, the detection record and flight record are associated to one another as described above and counts are adjusted to indicate the match. A match made during use of the secondary comparisons may be considered a match with a discrepancy, and a DISCREPANCY CODE may be added to the flight record. Suitable discrepancy codes for each type of secondary comparison are discussed in detail below.

Match with Wrong ISCI Same duration: Another example secondary comparison can be made in the same manner as described above with respect to a direct match. However, in this instance, a match is made even if the ISCI CODE of the detection record is not within the ISCI GROUP of the flight record, but is of the same agency-client-brand-product combination, and the DURATION of the detection record matches the LENGTH OF SPOT of the flight record.

If a match is found in this comparison, the detection record and flight record are associated to one another as described above and counts are adjusted to indicate the match.

Match with Wrong ISCI of Wrong Duration: Another example secondary comparison can be made in the same manner as described above with respect to a match with a wrong ISCI code. However, in this instance, a match is made if the ISCI CODE of the detection record is not within the ISCI GROUP of the flight record and the DURATION of the detection record is not the same as the DURATION of the flight record.

If a match is found in this comparison, the detection record and flight record are associated to one another as described above and counts are adjusted to indicate the match.

Match with an Extra Spot: In another example secondary comparison, detection records are compared to flight records to determine whether the detection record matches a flight record wherein the ITEM NUMBER field of the flight record has the form N of N (e.g., 3 of 3) and the flight record has already been associated with a detection record, which indicates that all the units of the line item of the buy information related to the flight record have already been satisfied. Specifically, detection records are compared to flight records in a manner similar to the direct comparison described above. However, the comparison is made to flight records that have already been associated with a detection record. Further, a match is made if all of the comparisons made with respect to a direct match are true and the ITEM NUMBER field of the flight record has the form N of N. In this instance, a match is made with an extra spot.

If an extra spot match is made, then a new flight record is created with the same information as the matched flight record. However, a value of “N+1 of N” (e.g., 4 of 3) is placed in the ITEM NUMBER field of the new flight record, to indicate that this is an extra spot. The matching anchor detection record and new flight record are associated to one another.

Match with an Extra Spot using the Primary Time Allowance: Another example secondary comparison can be made in the same manner as described with respect to the match with an extra spot. However, in this instance, the predetermined primary time allowance, as described above is permitted.

If a match is found in this comparison, the detection record and flight record are associated to one another as described above and counts are adjusted to indicate the match.

Match with a Secondary Time Allowance: Another example secondary comparison can be made in the same manner as described with respect to the primary time allowance, with a secondary time allowance greater than the first. If a match is found in this comparison, the detection record and flight record are associated to one another as described above and counts are adjusted to indicate the match.

Match with Wrong ISCI in an Extra Spot: Another example secondary comparison can be made in the same manner as described above with respect to a match with an extra spot. However, in this instance a match is made even if the ISCI CODE of the detection record is not within the ISCI GROUP of the flight record.

If a match is found in this comparison, the detection record and flight record are associated to one another as described above and counts are adjusted to indicate the match.

Match with Wrong ISCI of Wrong Duration in an Extra Spot: Another example secondary comparison can be made in the same manner as described above with respect to a match with an extra spot. However, in this instance a match is made even if the ISCI CODE of the detection record is not within the ISCI GROUP of the flight record and the DURATION of the detection record is not the same as the LENGTH OF SPOT of the flight record.

If a match is found in this comparison, the detection record and flight record are associated to one another as described above and counts are adjusted to indicate the match.

Discrepancies: As stated above, a match made during one of the secondary comparisons may be considered a match with a discrepancy. A discrepancy name and/or code may be placed in the flight record to indicate the type of discrepancy. Example DISCREPANCY NAME and DISCREPANCY CODE fields for inclusion in the flight record are as follows:

| DISCREPANCY NAME | DISCREPANCY CODE |
|---|---|
| Match with primary time allowance | WITHIN ALLOW |
| Wrong ISCI | WC |
| Wrong ISCI, wrong duration | WC DiffLen |
| Extra spot | EXTRA SPOT |
| Extra spot, primary allowance | EXTRA SPOT |
| Secondary time allowance | OUTSIDE ALLOW |
| Wrong ISCI, extra spot | WC EXTRA |
| Wrong ISCI, wrong duration | WC DiffLenExtra |

Custom Viewing and Reporting (Block 8 of the Example Process of FIG. 2)

The result of the detection and matching process is a series of tables which may be queried to produce reports as to fulfilled, unfulfilled and partially fulfilled (erroneous) broadcast orders.

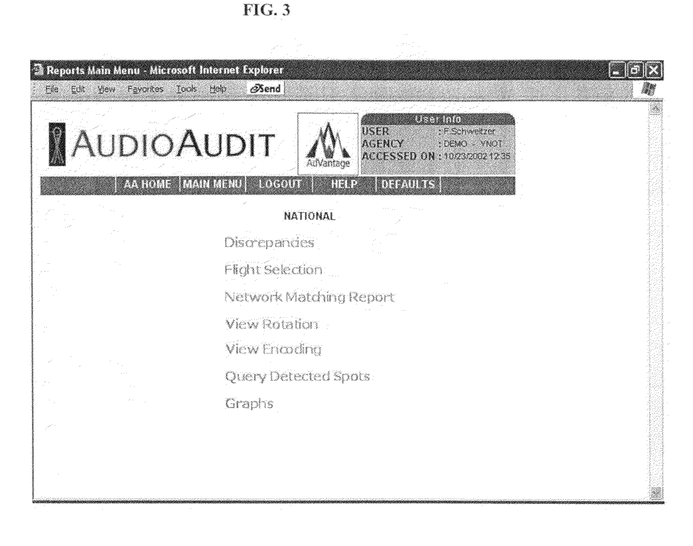

Referring to FIGS. 3-11, the example system of FIG. 2 provides summary and detailed reports on fulfilled and unfulfilled orders, as well as certain types of erroneously fulfilled orders, such as extra spots and wrong advertisements (i.e., wrong creative). The mutual, multiple associations between the flight records and the related detection records, and the associations between anchor detection records and related actual detection records provides the ability to obtain detailed information as to the bases for the reports. Preferably, the reports include links, such as “View Details” and “Drill Down” that display underlying information in increasing detail.

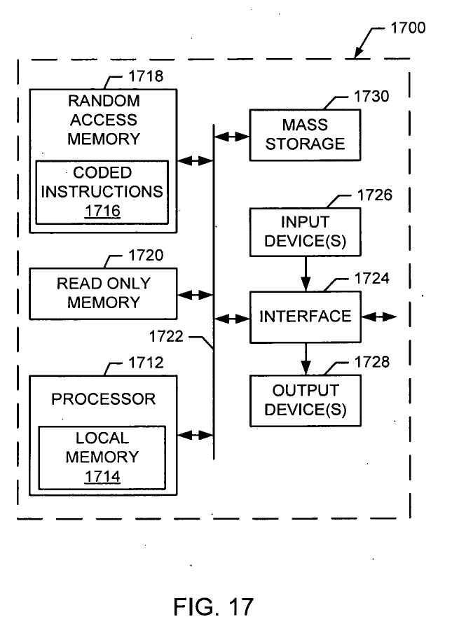

In an example implementation, the system of FIG. 2 implements a graphical user interface (GUI) to display output information and/or obtain input information via the example screens illustrated in FIGS. 3-11. In such an example implementation, the GUI may be implemented by machine readable instructions executed by the example processor 1712 included in the example computer 1700 of FIG. 17, which is described in greater detail below.

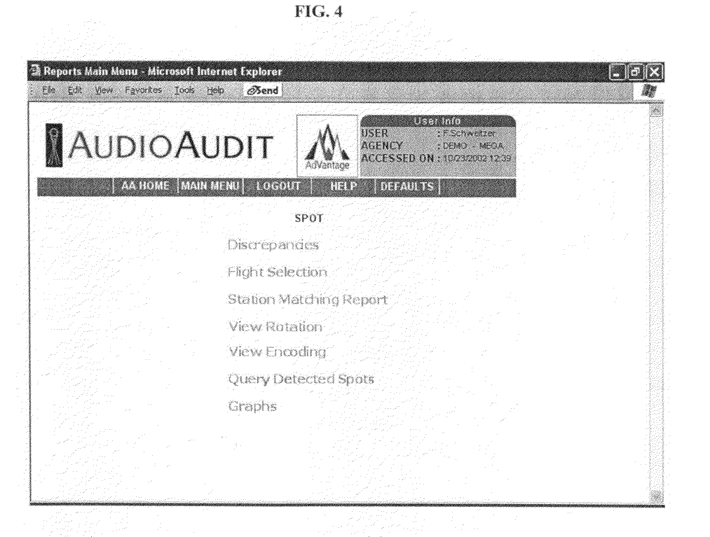

Referring to FIGS. 3 and 4, main screens provide one or more methods to query information on multi-market (e.g., national) and single-market advertising orders, respectively. Preferably, prior to producing this screen, the user has chosen a particular agency-client-brand-product combination to query.

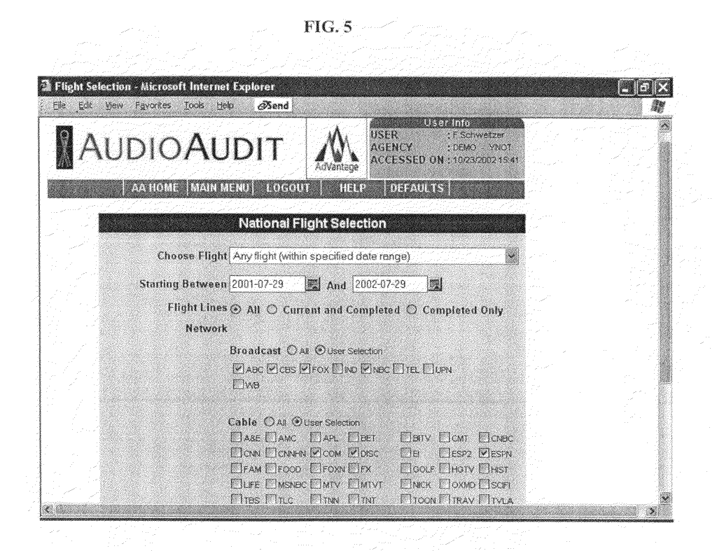

Referring to FIG. 5, a selection screen related to national flight selections provides a means to enter search criteria for obtaining information on specific flight orders, such as the date range and the network.

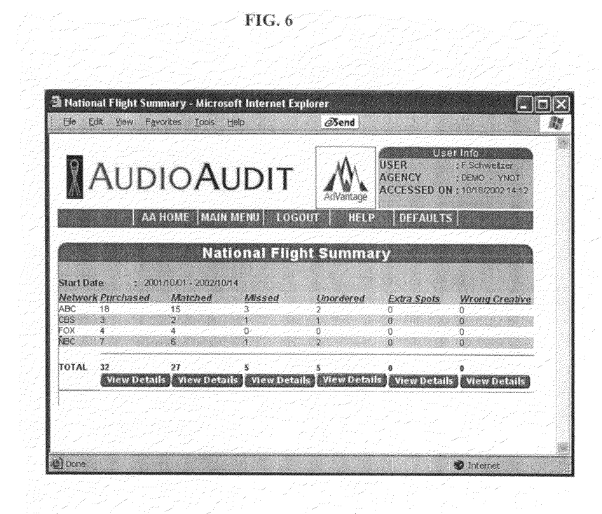

Referring to FIG. 6 search criteria entered in the selection screen of FIG. 5 will produce a National Flight Summary screen which provides summary information regarding the flight within the search criteria. The summary information includes the total number of spots purchased, matched, missed, unordered, extra spots, and wrong creative (i.e., wrong ISCI).

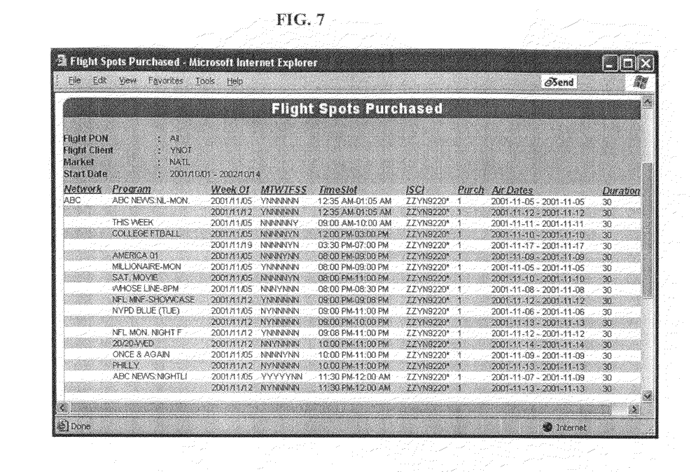

Referring to FIG. 7, selecting the “View Details” button, under the “Purchased” column of the National Flight Summary (FIG. 6) will produce a report of certain details regarding the flight information. This report provides details regarding the spots purchased with the flights display in FIG. 6.

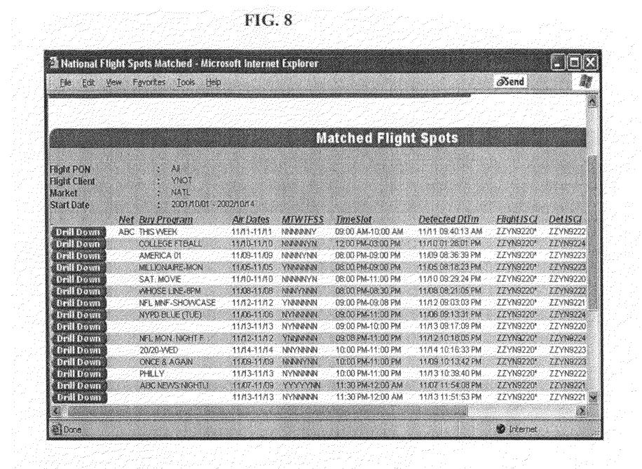

Referring to FIG. 8, selecting the “View Details” button under the “Matched” column of the National Flight Summary (FIG. 6) will produce a report of certain details regarding matched flight information. This report provides details on the anchor detections associated with the flights displayed in FIG. 6.

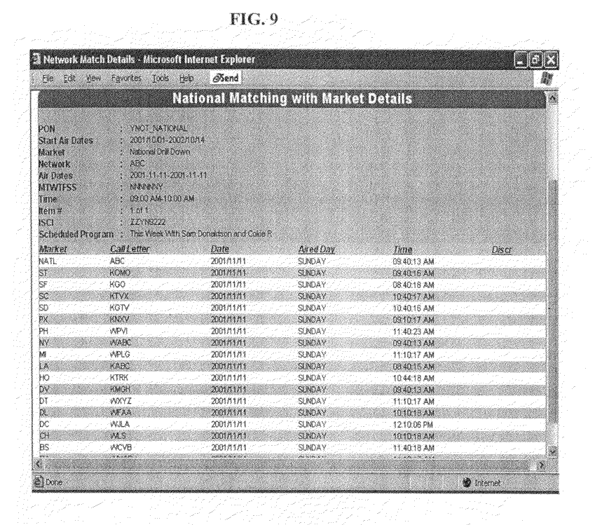

Referring to FIG. 9, further details regarding the actual market detections that are associated with such anchor market detections is available by selecting the associated “Drill Down” button in the report of FIG. 8, which action produces the report of FIG. 9. The report of FIG. 9 provides detailed information regarding individual actual market detections that comprise the associated anchor market detection.

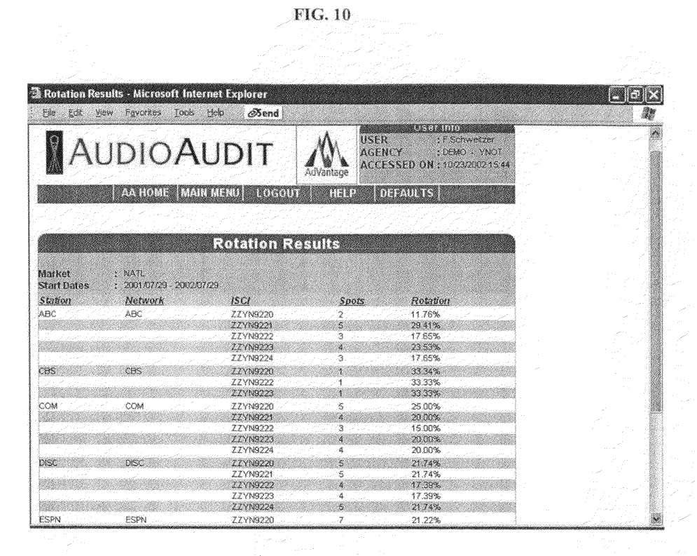

Referring to FIG. 10, the system also provides reports regarding the rotation of certain advertisements, based on the ISCI CODE.

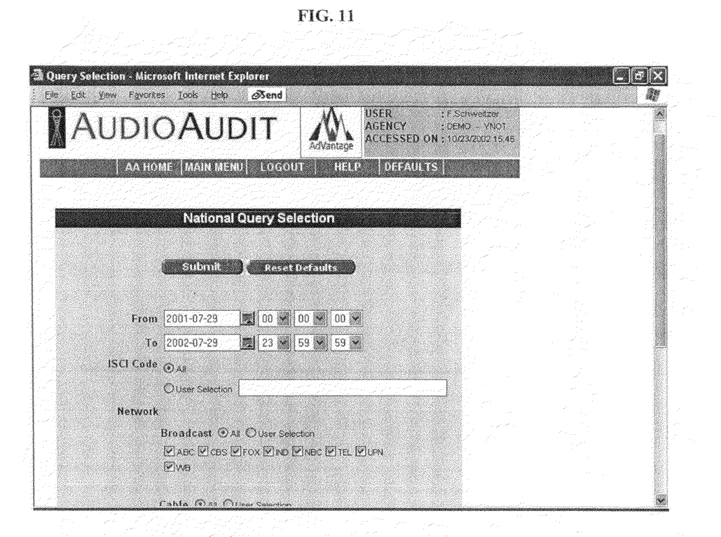

Referring to FIG. 11, the system also provides the user with the ability to perform ad hoc queries of the detection records based on, for example, the date range, ISCI code(s), and call letters.

As discussed above, flowcharts representative of example processes that may be executed to implement the example system of FIG. 2 and/or the example record association apparatus 1800 of FIG. 18, including some or all of the example schedule file loader 1810, the example schedule file processor 1820, the schedule file storer 1830, the example detection device interface 1840, the example detection information processor 1850, the example detection information storer 1860, the example detection association processor 1870 and/or the example multi-market association storer 1880, are shown in FIGS. 1, 16, and 19-23. In these examples, the process represented by each flowchart may be implemented by one or more programs comprising machine readable instructions for execution by: (a) a processor, such as the processor 1712 shown in the example computer 1700 discussed below in connection with FIG. 17, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1712, but the entire program or programs and/or portions thereof could alternatively be executed by a device other than the processor 1712 and/or embodied in firmware or dedicated hardware (e.g., implemented by an application specific integrated circuit (ASIC), a programmable logic device (PLD), a field programmable logic device (FPLD), discrete logic, etc.). For example, any or all of the example system of FIG. 2, the example record association apparatus 1800 of FIG. 18, the example schedule file loader 1810, the example schedule file processor 1820, the schedule file storer 1830, the example detection device interface 1840, the example detection information processor 1850, the example detection information storer 1860, the example detection association processor 1870 and/or the example multi-market association storer 1880 could be implemented by any combination of software, hardware, and/or firmware. Also, some or all of the processes represented by the flowcharts of FIGS. 1, 16, and 19-23 may be implemented manually. Further, although the example processes are described with reference to the flowcharts illustrated in FIGS. 1, 16, and 19-23, many other techniques for implementing the example methods and apparatus described herein may alternatively be used. For example, with reference to the flowcharts illustrated in FIGS. 1, 16, and 19-23, the order of execution of the blocks may be changed, and/or some of the blocks described may be changed, eliminated, combined and/or subdivided into multiple blocks.

FIG. 17 is a block diagram of an example computer 1700 capable of implementing the apparatus and methods disclosed herein. The computer 1700 can be, for example, a server, a personal computer, a personal digital assistant (PDA), an Internet appliance, a DVD player, a CD player, a digital video recorder, a personal video recorder, a set top box, or any other type of computing device.

The system 1700 of the instant example includes a processor 1712 such as a general purpose programmable processor. The processor 1712 includes a local memory 1714, and executes coded instructions 1716 present in the local memory 1714 and/or in another memory device. The processor 1712 may execute, among other things, machine readable instructions to implement the procedures represented in FIGS. 1 and/or 16. The processor 1712 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1712 is in communication with a main memory including a volatile memory 1718 and a non-volatile memory 1720 via a bus 1722. The volatile memory 1718 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1720 may be implemented by flash memory and/or any other desired type of memory device. Access to the main memory 1718, 1720 is typically controlled by a memory controller (not shown).

The computer 1700 also includes an interface circuit 1724. The interface circuit 1724 may be implemented by any type of interface standard, such as an Ethernet interface, a universal serial bus (USB), and/or a third generation input/output (3GIO) interface.

One or more input devices 1726 are connected to the interface circuit 1724. The input device(s) 1726 permit a user to enter data and commands into the processor 1712. The input device(s) can be implemented by, for example, a keyboard, a mouse, a touchscreen, a track-pad, a trackball, an isopoint and/or a voice recognition system.

One or more output devices 1728 are also connected to the interface circuit 1724. The output devices 1728 can be implemented, for example, by display devices (e.g., a liquid crystal display, a cathode ray tube display (CRT)), by a printer and/or by speakers. The interface circuit 1724, thus, typically includes a graphics driver card.

The interface circuit 1724 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1700 also includes one or more mass storage devices 1730 for storing software and data. Examples of such mass storage devices 1730 include floppy disk drives, hard drive disks, compact disk drives and digital versatile disk (DVD) drives. The mass storage device 1730 may implement, for example, the database 1630. Alternatively, the volatile memory 1718 may implement, for example, the database 1630.

As an alternative to implementing the methods and/or apparatus described herein in a system such as the device of FIG. 17, the methods and or apparatus described herein may be embedded in a structure such as a processor and/or an ASIC (application specific integrated circuit).

From the foregoing, methods, apparatus and systems for tracking, managing multi-market broadcast advertising have been disclosed that provide accurate, independent confirmations of the fulfillment of broadcast advertising orders. The disclosed example methods, apparatus and systems also provide significant advantages in matching multi-market broadcasts of advertisements to multi-market advertising orders, and in reporting fulfilled and unfulfilled orders. The disclosed example methods, apparatus and systems also provide such matching, confirmation and reporting for a large number of broadcasts over a large number of broadcast markets. Of course, the methods, apparatus and systems disclosed herein may also be readily adapted to verify the broadcasting of media content other than the broadcasting of commercial advertisements discussed above.

Finally, although certain example methods, apparatus, systems and articles of manufacture have been described herein, the scope of coverage of this patent is not limited thereto. On the contrary, this patent covers all methods, apparatus, systems and articles of manufacture fairly falling within the scope of the appended claims either literally or under the doctrine of equivalents.

What is claimed is:

1. A method to associate broadcast detection records from different broadcast markets with a multi-market media broadcast, the method comprising:
obtaining a plurality of broadcast detection records, each of the broadcast detection records comprising detection information obtained by detecting an instance of a broadcast item in a broadcast market;
comparing the plurality of broadcast detection records using first record association criteria to identify a first group of broadcast detection records from the plurality of broadcast detection records for associating with the multi-market media broadcast;
comparing the plurality of broadcast detection records using second record association criteria to identify a second group of broadcast detection records from the plurality of broadcast detection records for associating with the multi-market media broadcast, the second record association criteria being different from the first record association criteria; and
determining a third group of broadcast detection records from the plurality of broadcast detection records to associate with the multi-market media broadcast, the third group corresponding to a larger of the first group and the second group.

2. A method as defined in claim 1 further comprising creating an anchor detection record to represent the third group of broadcast detection records, the anchor detection record representative of a common broadcast item that is broadcast in a plurality of markets included in the multi-media market broadcast.

3. A method as defined in claim 1 wherein the broadcast item comprises a commercial and the multi-market media broadcast corresponds to a buy of commercial air time for broadcasting the commercial in a plurality of broadcast markets.

4. A method as defined in claim 1 wherein the detection information included in a particular broadcast detection record is obtained by detecting a code broadcast with the broadcast item, and wherein the detection information comprises date and time information corresponding to when the broadcast item was detected, at least one of an industry standard commercial identifier (ISCI) code or an Ad-ID code identifying the broadcast item, a call letter corresponding to a broadcaster of the broadcast item, and program schedule information corresponding to a scheduled broadcast program during the broadcast of which the broadcast item was detected, wherein the program schedule information is time adjusted to correspond to a base market.

5. A method as defined in claim 1 wherein the detection information included in a particular broadcast detection record is obtained by determining a signature corresponding to the broadcast item, and the detection information comprises date and time information corresponding to a time when the broadcast item was detected, at least one of an industry standard commercial identifier (ISCI) code or an Ad-ID code identifying the broadcast item, a call letter corresponding to a broadcaster of the broadcast item, and program schedule information corresponding to a scheduled broadcast program during the broadcast of which the broadcast item was detected, wherein the program schedule information is time adjusted to correspond to a predefined base market.

6. A method as defined in claim 1 wherein the first record association criteria comprise:
date and time information corresponding to a time when the broadcast item was detected, the date and time information being time adjusted to correspond to a base market;
a program name corresponding to a scheduled broadcast program during the broadcast of which the broadcast item was detected;
a distributor of the scheduled broadcast program; and
at least one of an industry standard commercial identifier (ISCI) code or an Ad-ID code identifying the broadcast item.

7. A method as defined in claim 1 wherein the first record association criteria comprise:
date and time information corresponding to a time when the broadcast item was detected, the date and time information being time adjusted to correspond to a base market;
a network identified specifying a network broadcasting a program during the broadcast of which the broadcast item was detected; and
at least one of an industry standard commercial identifier (ISCI) code or an Ad-ID code identifying the broadcast item.

8. A method as defined in claim 1 wherein the first record association criteria comprise:
date and time information corresponding to a time when the broadcast item was detected, the date and time information being time adjusted to correspond to a base market;
a program name corresponding to a scheduled broadcast program during the broadcast of which the broadcast item was detected;
a program string corresponding to the scheduled broadcast program, the program string comprising at least one of a program subtitle, an episode name or a syndicator indicator;
program time information corresponding an elapsed time of the scheduled broadcast program at which the broadcast item was detected, and at least one of an industry standard commercial identifier (ISCI) code or an Ad-ID code identifying the broadcast item.

9. A method as defined in claim 1 wherein the first record association criteria comprise:
date and time information corresponding to a time when the broadcast item was detected, the date and time information being time adjusted to correspond to a feed providing the broadcast item; and
at least one of an industry standard commercial identifier (ISCI) code or an Ad-ID code identifying the broadcast item.

10. A method as defined in claim 1 wherein comparing the plurality of broadcast detection records further comprises selecting a first broadcast detection record that is not associated with any multi-market media broadcast to compare with a second broadcast record to determine whether the first and second broadcast detection records are associated with at least one multi-market media broadcast.

11. A method as defined in claim 1 further comprising comparing the third group of broadcast detection records associated with the multi-market media broadcast with flight information representative of a buy of commercial air time for broadcasting the broadcast item in a plurality of broadcast markets to determine whether the buy was satisfied.

12. A method as defined in claim 1 further comprising:
determining whether the first group exceeds a threshold number of broadcast detection records included therein; and
permitting the first group to be compared with the second group to determine the third grouping if the first group exceeds the threshold, but not if the first group fails to exceed the threshold.

13. An article of manufacture storing machine readable instructions which, when executed, cause a machine to:
obtain a plurality of broadcast detection records, each of the broadcast detection records comprising detection information obtained by detecting an instance of a broadcast item in a broadcast market;
compare the plurality of broadcast detection records using first record association criteria to identify a first group of broadcast detection records from the plurality of broadcast detection records for associating with a multi-market media broadcast;
compare the plurality of broadcast detection records using second record association criteria to identify a second group of broadcast detection records from the plurality of broadcast detection records for associating with the multi-market media broadcast, the second record association criteria being different from the first record association criteria; and
determine a third group of broadcast detection records from the plurality of broadcast detection records to associate with the multi-market media broadcast, the third group corresponding to a larger of the first group and the second group.

14. An article of manufacture as defined in claim 13 wherein the plurality of broadcast detection records are obtained based on at least one of detection of a code broadcast with a broadcast item or determination of a signature representative of the broadcast item.

15. An article of manufacture as defined in claim 13 wherein the machine readable instructions, when executed, further cause the machine to compare the third group of broadcast detection records associated with the multi-market media broadcast with flight information representative of a buy of commercial air time for broadcasting a broadcast item in a plurality of broadcast markets to determine whether the buy was satisfied.

16. A system to associate broadcast detection records from different broadcast markets with a multi-market media broadcast, the system comprising:
a plurality of detection devices configured to detect media broadcasts in a respective plurality of broadcast markets; and
a central processing site configured to:
receive first detection information from each detection device;
create a plurality of broadcast detection records corresponding respectively to the plurality of detection devices, each of the broadcast detection records comprising second detection information formed by combining the first detection information with broadcast program schedule information;
compare the plurality of broadcast detection records using first record association criteria to identify a first group of broadcast detection records from the plurality of broadcast detection records for associating with the multi-market media broadcast;
compare the plurality of broadcast detection records using second record association criteria to identify a second group of broadcast detection records from the plurality of broadcast detection records for associating with the multi-market media broadcast, wherein the second record association criteria is different from the first record association criteria; and
determine a third group of broadcast detection records from the plurality of broadcast detection records to associate with the multi-market media broadcast, wherein the third group corresponds to a larger of the first group and the second group.

17. A system as defined in claim 16 wherein the central processing site is further configured to create an anchor detection record to represent the third group of broadcast detection records determined to be associated with the multi-market media broadcast, the anchor detection record representative of a common broadcast item that is broadcast in a plurality of markets included in the multi-media market broadcast.

18. A system as defined in claim 16 wherein the central processing site is further configured to compare the third group of broadcast detection records associated with the multi-market media broadcast with flight information representative of a buy of commercial air time for broadcasting a broadcast item in a plurality of broadcast markets to determine whether the buy was satisfied.

19. A system as defined in claim 16 wherein each detection device is further configured to at least one of detect a code broadcast with a broadcast item or determine a signature representative of a broadcast item.

20. A system as defined in claim 16 wherein the first detection information comprises:
an identifier of the detection device;
date and time information corresponding to when a broadcast item was detected;
at least one of an industry standard commercial identifier (ISCI) code or an Ad-ID code identifying the broadcast item; and
at least one of a call letter or broadcast channel corresponding to a source of the broadcast item.

21. An apparatus to associate broadcast detection records from different broadcast markets with a multi-market media broadcast, the apparatus comprising:
a detection information processor to determine a plurality of broadcast detection records, each of the broadcast detection records comprising detection information obtained from a respective detection device detecting an instance of a broadcast item in a respective broadcast market; and
a detection association processor to:
compare the plurality of broadcast detection records using first record association criteria to identify a first group of broadcast detection records from the plurality of broadcast detection records for associating with the multi-market media broadcast;
compare the plurality of broadcast detection records using second record association criteria to identify a second group of broadcast detection records from the plurality of broadcast detection records for associating with the multi-market media broadcast, the second record association criteria being different from the first record association criteria; and
determine a third group of broadcast detection records from the plurality of broadcast detection records to associate with the multi-market media broadcast, the third group corresponding to a larger of the first group and the second group.

22. An apparatus as defined in claim 21 wherein the detection association processor is to further create an anchor detection record to represent the third group of broadcast detection records, the anchor detection record representative of a common broadcast item that is broadcast in a plurality of markets included in the multi-media market broadcast.

23. An apparatus as defined in claim 21 further comprising a schedule file processor to: (1) process schedule information corresponding to the broadcast markets potentially included in the multi-market media broadcast, and (2) adjust date and time information obtained from at least some detection devices to correspond to a base market, the adjusted date and time information for inclusion in at least some of the plurality of broadcast detection records.
